(19) United States
(12) Patent Application Publication
(10) Pub. No.: US 2024/0051086 A1
(43) Pub. Date: Feb. 15, 2024

(54) Material Collection Device

(71) Applicant: Robert Bosch GmbH, Stuttgart (DE)

(72) Inventors: Florian Esenwein, Leinfelden-Echterdingen (DE); Simon Riggenmann, Stuttgart (DE); Adamo Sadikovic, Renningen (DE)

(21) Appl. No.: 18/249,290

(22) PCT Filed: Sep. 22, 2021
(86) PCT No.: PCT/EP2021/076049

§ 371 Date: Oct. 26, 2023

(30) Foreign Application Priority Data
Oct. 20, 2020 (DE) 10 2020 213 228.3
Oct. 20, 2020 (DE) 10 2020 213 229.1
Oct. 20, 2020 (DE) 10 2020 213 230.5
Oct. 20, 2020 (DE) 10 2020 213 231.3

(51) Int. Cl. B24B 55/10

(52) U.S. Cl. CPC B24B 55/105

(57) ABSTRACT

A material collection device for a hand-held power tool includes a material collection container for collecting material removed during operation of the hand-held power tool. At least one opening of the material collection container is for feeding the material into the material collection container and is arranged in an opening plane. At least one mounting unit is for mounting the material collection container on the hand-held power tool. The at least one mounting unit includes a channel element for connection to an ejection port of the hand-held power tool. A channel longitudinal axis of the channel element is arranged transversely to the opening plane of the material collection container in at least one section plane running perpendicularly to the opening plane.

This application is a 35 U.S.C. § 371 National Stage Application of PCT/EP2021/076049, filed on Sep. 22, 2021, which claims the benefit of priority to (i) Serial No. DE 10 2020 213 230.5, filed on Oct. 20, 2020 in Germany; (ii) Serial No. DE 10 2020 213 228.3, filed on Oct. 20, 2020 in Germany; (iii) Serial No. DE 10 2020 213 229.1, filed on Oct. 20, 2020 in Germany; and (iv) Serial No. DE 10 2020 213 231.3, filed on Oct. 20, 2020 in Germany the disclosures of which are incorporated herein by reference in their entirety.

### BACKGROUND

A material collection device for a hand-held power tool, with a material collection container for collecting material removed during operation of the hand-held power tool, wherein at least one opening of the material collection container for feeding the material into the material collection container is arranged in an opening plane, and with at least one mounting unit for mounting the material collection container on the hand-held power tool, has already been proposed.

US 2016/0184963 A1 has already proposed a hand-held grinding machine with at least one grinding device for receiving or forming a grinding means, wherein the grinding device comprises at least one fan for transporting away material removed during a grinding operation, with at least one drive device for driving the grinding device and with at least one connection housing unit, which at least partially receives the grinding device.

U.S. Pat. No. 4,624,078 has already proposed a hand-held grinding machine with at least one grinding device for receiving or forming a grinding means, with a drive device for driving the grinding device, with a drive housing receiving the drive device, and with an interface device for operatively connecting the grinding device to the drive device, wherein the interface device comprises at least one connection housing unit, formed separately from the drive housing and the grinding device, for at least partially receiving the grinding device, and a docking interface arranged on the drive housing, wherein the connection housing unit encompasses the docking interface in a fixing plane perpendicular to a rotation axis of a drive shaft of the drive device.

A hand-held grinding machine with at least one grinding device for receiving or forming a grinding means, with a drive device for driving the grinding device, with at least one actuating element for controlling the drive device, and with a drive housing which receives the drive device and has a longitudinal axis portion, which is arranged about a longitudinal axis at least substantially perpendicular to a rotation axis of the drive device, and comprises a front portion, which surrounds an intersection region of the rotation axis and of the longitudinal axis, has already been proposed.

### SUMMARY

The disclosure relates to a material collection device for a hand-held power tool, with a material collection container for collecting material removed during operation of the hand-held power tool, in particular by means of the hand-held power tool, wherein at least one opening of the material collection container for feeding the material into the material collection container is arranged in an opening plane, and with at least one mounting unit for mounting the material collection container on the hand-held power tool.

It is proposed that the mounting unit comprises a channel element for connection to an ejection port of the hand-held power tool, wherein a channel longitudinal axis of the channel element is arranged transversely to the opening plane of the material collection container in at least one section plane running perpendicularly to the opening plane. The material collection device is in particular provided for collecting material that is mechanically separated and/or removed from a workpiece by the hand-held power tool. The material may in particular be dust, chips, abraded material, or the like. For example, the hand-held power tool may be designed as a grinding machine, a polishing machine, a planing machine, a drilling machine, a milling machine, a sawing machine, or the like. The hand-held power tool can preferably be held with one or two hands, in particular without a transport and/or holding device, and in particular be guided and operated by hand during workpiece machining. The term “provided” is understood in particular to mean specifically configured, specifically programmed, specifically designed, and/or specifically equipped. An object being provided for a particular function is understood in particular to mean that the object fulfills and/or performs this particular function in at least one application state and/or operating state.

Preferably, the material collection container is cylindrical, alternatively cuboid, frusto-conical, frusto-pyramidal, or the like. The material collection container preferably comprises a container longitudinal axis that is perpendicular to the opening plane. In particular, the material collection container has the largest longitudinal extension in parallel to, in particular along, the container longitudinal axis. The container longitudinal axis is in particular designed as the container center axis. Preferably, the material collection container is formed at least substantially rotationally symmetrically about the container longitudinal axis. A maximum opening width of the opening preferably extends over more than 50%, preferably more than 75%, in particular more than 85% of a maximum transverse extension of the material collection container in the opening plane. Preferably, the material collection container comprises a container region for accumulating the material. Preferably, the material collection container comprises a fastening ring for fastening to the mounting unit. In particular, the container region is designed to be air-permeable. For example, the container region comprises a textile fabric, particularly preferably a nonwoven fabric. Preferably, the container region is formed in at least two layers, in particular with a filter layer, in particular from the nonwoven fabric, and a support layer, in particular a textile support layer, which stabilizes the shape of the container region and is made, for example, from a nylon knitted fabric, a coarse-meshed fabric, a wire mesh, or the like. In particular, the filter layer faces a container interior of the material collection container. Preferably, the support layer forms an outside of the container region, in particular in order to achieve an advantageously long service life of the material collection container. Optionally, the material collection container additionally comprises a support element, for example a frame and/or a housing, which is made of plastic and/or metal and is arranged on the filter layer and/or the support layer in order to support a shape of the material collection container. Alternatively, the filter layer is designed as a pleated filter. The fastening ring is preferably arranged in the opening plane and may have rotationally symmetrically arranged fastening elements or fastening elements breaking a rotational symmetry of the material collection container. Preferably, the container region is fastened to the fastening ring by means of a catch connection. Alternatively, the container region is connected or fastened to the fastening ring in a material fit with separately formed fixing means, such as in particular screws, rivets, cramps, or the like.

The material collection container is in particular arranged in the opening plane on the mounting unit. The channel element is in particular tubular. Particularly preferably, an inner wall of the channel element is designed rotationally symmetrically to the channel longitudinal axis. In particular, the channel longitudinal axis specifies a main flow direction through the channel element from an inlet opening of the channel element to an outlet opening of the channel element. The channel longitudinal axis is preferably designed as the channel center longitudinal axis. The outlet opening of the channel element in particular faces the opening of the material collection container. Preferably, the channel element is arranged spaced apart from the opening plane. Alternatively, the opening plane intersects the channel element. The inlet opening of the channel element is in particular provided to be arranged facing the hand-held power tool. The channel element is in particular provided to receive the ejection port of the hand-held power tool. Alternatively, the channel element is provided to be received by the ejection port. In particular, the channel longitudinal axis has an angle different from 90° to the opening plane. In particular, the channel longitudinal axis and the opening plane enclose an acute angle. Preferably, the angle between the opening plane and the channel longitudinal axis in the section plane is between 30° and 60°, preferably between 40° and 50°, particularly preferably between 44° and 46°. Preferably, the section plane comprises the container longitudinal axis.

As a result of the design according to the disclosure, the container longitudinal axis differs from the channel longitudinal axis. In particular, during a rotation of the material collection device about the ejection port, the container longitudinal axis differs from a rotation axis defined by the ejection port. In particular, a position of the material collection container relative to the hand-held power tool in a state of the material collection device connected to the ejection port may be changed. In particular, a position of the material collection container relative to the hand-held power tool and/or a workpiece can advantageously be flexibly adapted. In particular, the material collection container can be arranged on the hand-held power tool so as to rotate and/or pivot relative to the hand-held power tool.

It is furthermore proposed that the channel longitudinal axis is arranged transversely to the opening plane in a further section plane perpendicular to the section plane and the opening plane. In particular, the channel longitudinal axis and the container longitudinal axis are arranged skew to one another. Alternatively, the channel longitudinal axis and the container longitudinal axis have a common intersection point. Preferably, an angle between the channel longitudinal axis and the opening plane in the further section plane is between 10° and 40°, preferably between 15° and 30°. Preferably, the further section plane comprises the container longitudinal axis. In particular, the container longitudinal axis is an intersection line of the section plane and the further section plane. As a result of the design according to the disclosure, the collection container can advantageously be arranged in an inclined manner against a workpiece and/or an inclination of the ejection port relative to the workpiece can advantageously be compensated.

It is furthermore proposed that the mounting unit comprises an adapter housing which is asymmetrically tapered from the opening plane in the direction of the channel longitudinal axis and into which the channel element at least partially projects. Preferably, the channel element is arranged at least substantially completely, in particular at least 50%, preferably more than 75% with respect to a maximum extension of the channel element parallel to, in particular along, the channel longitudinal axis, in the interior of the adapter housing. Preferably, the adapter housing connects the channel element to the fastening ring of the material collection container. Particularly preferably, the adapter housing is formed integrally with the channel element. Preferably, the adapter housing is arranged flush with the collection container in the opening plane. Preferably, the adapter housing narrows a maximum cross section of the material collection container parallel to the opening plane to a maximum cross section of the channel element perpendicular to the channel longitudinal axis. Preferably, the adapter housing and the fastening ring comprise complementary mounting elements to one another, for example an internal thread and an external thread, a catch tongue and a catch receptacle, or the like. In particular, the mounting elements of the fastening ring and of the adapter housing are provided for connection of the material collection container and of the adapter housing that can be non-destructively detached and established again by hand. Particularly preferably, the part of the adapter housing forming the tapering is designed in the form of a truncated cone seated askew on the fastening ring. As a result of the design according to the disclosure, a maximum channel transverse extension of the channel element can be designed, in particular independently of a maximum opening mode of the opening. In particular, the same collection container can be used for different hand-held power tools with in particular different ejection ports by replacing the mounting unit.

Furthermore, it is proposed that an inlet opening, in particular the already mentioned inlet opening, of the channel element extends in a plane that is at least substantially perpendicular to the channel longitudinal axis and in particular transverse to the opening plane. The term “substantially perpendicular” is to be understood here in particular to mean an orientation of a direction relative to a reference direction, wherein the direction and the reference direction, in particular as viewed in a projection plane, enclose an angle of 90°, and the angle has a deviation of in particular less than 8°, advantageously less than 5°, and particularly advantageously less than 2°. Preferably, the outlet opening is arranged at least substantially in parallel to the inlet opening. In particular, the channel element forms a stop element at the outlet opening for a form fit, parallel to the channel longitudinal axis, with the ejection port. Optionally, the channel element forms a further stop element at the inlet opening for a form fit, parallel to the channel longitudinal axis, with the ejection port. In particular, the inlet opening encompasses the ejection port in a state of the material collection device arranged on the ejection port. As a result of the design according to the disclosure, a risk of a special embodiment of the ejection port restricting a rotation range or a swivel range of the material collection device about the channel longitudinal axis can advantageously be kept low. In particular, an abutment, caused by a rotation, of the material collection device on an element of the ejection port and/or a housing of the hand-held power tool forming the ejection port can advantageously be kept low.

Furthermore, it is proposed that an inlet opening, in particular the already mentioned inlet opening, of the channel element is arranged spaced apart from a container longitudinal axis of the material collection container that is perpendicular to the opening plane, in particular the already mentioned container longitudinal axis. In particular, the container longitudinal axis has an intersection point with the adapter housing. Preferably, the container longitudinal axis has an intersection point with the channel element. Particularly preferably, two planes that are perpendicular to one another and have the container longitudinal axis as the intersection line, in particular the section plane and the further section plane, divide the material collection device into four quadrants, which in particular each comprises one quarter of the collection container. Preferably, the inlet opening is arranged entirely in one of the quadrants. Preferably, the outlet opening is distributed over several of the four, in particular all four, quadrants, in particular unequally. In particular, the container longitudinal axis passes through the outlet opening. Preferably, the outlet opening protrudes at most slightly beyond an outer contour of the collection container in a plane parallel to the opening plane. In particular, tangent planes touching the squares that do not comprise the inlet opening do not intersect the inlet opening or the channel element. As a result of the design according to the disclosure, an advantageously long receiving space of the channel element for receiving the ejection port can be achieved. In particular, the material device can advantageously be securely arranged on the ejection port. In particular, a tilting of the channel longitudinal axis of the channel element relative to a channel longitudinal axis of the ejection port can advantageously be kept small.

Furthermore, it is proposed that a maximum adapter longitudinal extension of a portion of the mounting unit protruding beyond the material collection container is less than or equal to a maximum adapter transverse extension of the mounting unit in the opening plane. In particular, a ratio of the adapter longitudinal extension to the adapter transverse extension is between 50% and 80%, preferably between 60% and 70%. The maximum adapter longitudinal extension is in particular perpendicular to the opening plane and is in particular parallel to the container longitudinal axis. In particular, the maximum adapter longitudinal extension is spaced apart from the container longitudinal axis. Preferably, the maximum adapter transverse extension is in the opening plane. Preferably, the maximum adapter transverse extension is at least substantially equal to the maximum transverse extension of the collection container in a plane parallel to the opening plane. In particular, the maximum adapter transverse extension is between 90% and 110%, preferably between 95% and 105% of the maximum transverse extension of the collection container. As a result of the design according to the disclosure, the mounting unit can advantageously be kept compact. In particular, a maximum longitudinal extension of the material collection device parallel to the container longitudinal axis can advantageously be kept small or the container region can be designed to be advantageously large. In particular, a projection of the orifice beyond the collection container can advantageously be kept small. In particular, a rotation path of the material collection container about the channel longitudinal axis can advantageously be kept small, in particular so that an advantageously large swivel angle can be achieved, at which the material collection container can be rotated about the channel longitudinal axis without collision with the hand-held power tool and/or the workpiece.

It is furthermore proposed that an outlet opening, in particular the already mentioned outlet opening, of the channel element assumes a maximum outlet opening width of between 35% and 55%, preferably between 40% and 50%, the maximum opening width of the opening in the opening plane. Preferably, a ratio of the maximum channel transverse extension, in particular an inner diameter of the channel element perpendicular to the channel longitudinal axis, to the opening width of the opening is between 30% and 60%, preferably between 45% and 55%. Particularly preferably, the outlet opening width is smaller than the maximum channel transverse extension, in particular for forming a stop for the ejection port. Preferably, the outlet opening of the channel element is arranged in a plane that is at least substantially perpendicular to the channel longitudinal axis and transverse to the opening plane. A geometric center of the outlet opening of the channel element is arranged at least in the further section plane, in particular at an offset from the container longitudinal axis, in particular by an amount of 10% to 30% of the maximum opening width. The geometric center point of the outlet opening is preferably arranged in a different quadrant than the inlet opening. In particular, the geometric center point of the outlet opening is arranged on the same side of the section plane as the inlet opening. In particular, the geometric center point of the outlet opening and the inlet opening are arranged on different sides of the further section plane. As a result of the design according to the disclosure, an angle of deflection of an air flow fed into the container device through the channel element can advantageously be kept small and the ejection port can advantageously be arranged deep in the material collection device at the same time.

In addition, a hand-held power tool with a material collection device according to the disclosure is proposed. The hand-held power tool in particular comprises a tool device for receiving or forming a machining tool, in particular a grinding means, a drill head, a saw blade, or the like. The hand-held power tool in particular comprises a drive device for driving the tool device. In particular, the drive device comprises a drive shaft defining a rotation axis. The hand-held power tool in particular comprises a drive housing in which the drive device is arranged. Preferably, the hand-held power tool comprises a connection housing unit in which the tool device and optionally a workpiece are at least partially arranged. The drive housing and the connection housing unit may be formed integrally or separately from one another. The connection housing unit is preferably firmly connected to the drive housing. Preferably, the connection housing unit comprises the ejection port. Preferably, the ejection port and the channel element are arranged on and coaxially with one another. Preferably, the tool device comprises a fan for conveying the material through the ejection port into the material collection container. Preferably, the drive housing comprises a longitudinal axis in the direction of which the drive housing has the greatest extension. In particular, in at least one rotational position of the collection container, the container longitudinal axis can be oriented at least substantially in parallel to the longitudinal axis of the drive housing or the rotation axis of the drive device. Preferably, in at least one rotational position of the collection container, the container longitudinal axis can be oriented at an angle of more than 20°, in particular more than 30°, particularly preferably more than 40°, to the longitudinal axis or the rotation axis. As a result of the design according to the disclosure, a hand-held power tool with an advantageously flexibly arrangeable material collection device can be provided. In particular, the hand-held power tool can also advantageously be used in confined spaces and/or on uneven workpieces.

It is furthermore proposed that a container longitudinal axis of the material collection container that is perpendicular to the opening plane, in particular the already mentioned container longitudinal axis, encloses an angle relative to a mounting plane, spanned by a longitudinal axis perpendicular to a rotation axis, in particular the already mentioned rotation axis, of a drive shaft, in particular the already mentioned drive shaft, of the power tool and the rotation axis, which angle added to an angle between the channel longitudinal axis and the container longitudinal axis forms a sum angle of between 80° and 100°, in particular between 85° and 95°, particularly preferred between 89° and 91°. In particular, when the material collection container is rotated about the channel longitudinal axis, the container longitudinal axis extends along lateral cone surface with an opening angle of less than 60°, in particular less than 50°, particularly preferably less than 46°, and in particular greater than 10°, preferably greater than 20°, particularly preferably greater than 44°. As a result of the design according to the disclosure, the container longitudinal axis can be oriented in parallel to the longitudinal axis of the drive housing.

It is furthermore proposed that a container longitudinal axis perpendicular to the opening plane in the state of the material collection device mounted on the hand-held power tool can be arranged at least substantially in parallel to a mounting plane spanned by a longitudinal axis, perpendicular to a rotation axis of a drive shaft of the power tool, of a drive housing of the power tool and the rotation axis, in particular wherein the container longitudinal axis is oriented in parallel to the longitudinal axis. Particularly preferably, in a rotational position oriented in parallel to the longitudinal axis, the container longitudinal axis is at least substantially parallel to a working plane of the hand-held power tool. The working plane is in particular perpendicular to an output rotation axis of the tool device. Particularly preferably, the output rotation axis is parallel or identical to the rotation axis of the drive device. In an alternative design, the rotation axis of the drive device is arranged in parallel to the longitudinal axis of the drive housing and perpendicular to the output rotation axis, wherein the mounting plane is in particular spanned by the longitudinal axis and the output rotation axis. By the design according to the disclosure, the material collection device can be oriented in at least one rotational position on the hand-held power tool that advantageously takes up little space and in particular has an advantageously low risk of abutting and/or getting caught on an object in the working area of the hand-held power tool. In addition, a risk of tilting the hand-held power tool relative to a workpiece can advantageously be kept low. In particular, an advantageously stable hand-held power tool can be provided.

In addition, it is proposed that the hand-held power tool comprises a drive housing that has a distance from the material collection container of between 10 mm and 40 mm, preferably between 15 mm and 35 mm, particularly preferably between 20 mm and 30 mm. In particular, the drive housing has a gripping surface. In particular, the gripping surface has the aforementioned distance to the material collection container. The aforementioned distance applies in particular when the material collection device is arranged on the ejection port and the container longitudinal axis of material collection container is oriented at least substantially in parallel to the longitudinal axis of the drive housing. Preferably, at least in the majority of all possible rotational positions of the material collection container, at least the gripping surface has a greater distance from the gripping surface than when the container longitudinal axis is oriented in parallel to the longitudinal axis of the drive housing. The aforementioned distance relates in particular to a distance perpendicular to the mounting plane. As a result of the design according to the disclosure, one or more fingers can advantageously be placed between the drive housing and the material collection container. In particular, the material collection container is advantageously far away from the drive housing, in particular the gripping surface. In particular, a hand-holding position of the hand-held power tool is advantageously little restricted by the material collection container.

The material collection device according to the disclosure and/or the hand-held power tool according to the disclosure is/are not to be limited to the above-described application and embodiment. In order to fulfill a functionality described herein, the material collection device according to the disclosure and/or the hand-held power tool according to the disclosure can in particular comprise a number of individual elements, components, and units that deviates from a number mentioned herein. Moreover, in the case of the value ranges specified in this disclosure, values within the mentioned limits are also to be considered as disclosed and usable as desired.

The disclosure relates to a hand-held grinding machine with at least one grinding device for receiving or forming a grinding means, wherein the grinding device comprises at least one fan for transporting away material removed during a grinding operation, with at least one drive device for driving the grinding device and with at least one connection housing unit, which at least partially receives the grinding device.

It is proposed that an inner wall of the connection housing unit that delimits a fan receiving region, is designed to guide an air flow, generated by the fan, in a funnel shape about a rotation axis of a drive shaft of the drive device. The hand-held grinding machine can preferably be held with one hand, in particular without a transport and/or holding device, and in particular be guided and operated by the same hand during a grinding operation. The hand-held grinding machine may be designed as a random orbit sander, a positively driven random orbit sander, an oscillating sander, a triangular sander, a polisher, or the like. The grinding means can, for example, be designed as a sand paper, as a sanding sponge, as an abrasive nonwoven fabric, as an abrasive fabric, as a polishing sponge, as an abrasive disk, as a buffing wheel, or the like. In particular, the grinding device comprises at least one grinding pad with a planar base surface, which is in particular at least substantially perpendicular to the rotation axis and which is provided for fastening the grinding means. The term “provided” is understood in particular to mean specifically configured, specifically programmed, specifically designed, and/or specifically equipped. An object being provided for a particular function is understood in particular to mean that the object fulfills and/or performs this particular function in at least one application state and/or operating state. The term “substantially perpendicular” is to be understood here in particular to mean an orientation of a direction relative to a reference direction, wherein the direction and the reference direction, in particular as viewed in a projection plane, enclose an angle of 90°, and the angle has a deviation of in particular less than 8°, advantageously less than 5°, and particularly advantageously less than 2°.

Preferably, the drive device is arranged in a drive housing of the hand-held grinding machine. The connection housing unit is arranged in particular in the direction of the rotation axis on the drive housing. The connection housing unit and the drive housing may be formed separately from one another or integrally. The fan received by the connection housing unit is preferably arranged in the direction of the rotation axis between the grinding pad and the drive device. Preferably, the fan is aligned coaxially with the drive shaft. Alternatively, the fan is aligned coaxially with an eccentric axis of the grinding device. The fan may be arranged directly on the drive shaft or may be connected to the drive shaft by means of a separately formed transmission element in order to be driven by the drive shaft. A maximum extension of the connection housing unit parallel to the rotation axis preferably extends completely over a parallel maximum extension of the fan. In particular, the connection housing unit delimits the fan receiving region at least in a plane perpendicular to the rotation axis. In the direction of the rotation axis, the fan receiving region is delimited at least by the drive housing, the grinding pad and/or the connection housing unit. A maximum transverse extension of the fan receiving region perpendicular to the rotation axis is preferably smaller than a maximum transverse extension of the grinding pad perpendicular to the rotation axis. Preferably, a slip ring is arranged between the connection housing unit and the grinding pad, which slip ring is fastened to the connection housing unit, in particular pressed into a groove, and rests on the grinding pad. In particular, the connection housing unit comprises an air inlet arranged on a bottom portion of the connection housing unit facing the grinding pad. Preferably, a transmission of the grinding device connecting the grinding pad to the drive shaft projects through the air inlet. A geometric central axis of a wall of the connection housing unit delimiting the air inlet is preferably arranged coaxially with the rotation axis. The connection housing unit preferably comprises an ejection port, in particular for connecting a material collection device and/or a suction device, which ejection port comprises an orifice by means of which the ejection port is fluidly connected to the fan receiving region. In particular, the fan is provided to generate an air flow from the air inlet through the connection housing unit to the ejection port, which air flow entrains the removed material. The fan is preferably designed as a radial fan. In particular, the fan comprises blades facing the air inlet. In particular, the fan comprises a base plate to which the blades are fastened and which faces the drive device.

A receiving radius of the fan receiving region in particular describes a distance of the inner wall of the connection housing unit from the rotation axis in a direction perpendicular to the rotation axis. Preferably, the receiving radius of the funnel-shaped fan receiving region on the base plate of the fan is greater than that of the air inlet. Preferably, the receiving radius of the funnel-shaped fan receiving region widens starting from the air inlet in the direction of the rotation axis, in particular to the base plate of the fan. In particular, the receiving radius of the funnel-shaped fan receiving region has a maximum in the base plate of the fan, in particular irrespective of the orifice. In particular, the maximum of the receiving radius of the fan receiving region, which maximum is in particular spaced apart from the orifice, is at least 10%, preferably more than 15%, particularly preferably more than 20%, greater than a value of the receiving radius at the air inlet. An opening width of the air inlet is preferably smaller than the receiving radius of the fan receiving region at the air inlet. In particular, the bottom portion has a surface that faces the fan, is at least substantially perpendicular to the rotation axis and in particular delimits the air inlet. The receiving radius increases, preferably continuously, in particular without jumps and/or monotonically, optionally strictly monotonically, along the rotation axis starting from the bottom portion, in particular irrespective of the orifice. A difference quotient of the receiving radius with respect to a position along the rotation axis may be continuous or may have jumps. On a side of the maximum of the receiving radius facing away from the air inlet, the fan receiving region tapers, in particular in order to adjust a cross section of the connection housing unit perpendicular to the rotation axis to a cross section of a portion of the drive housing facing the connection housing unit.

As a result of the design according to the disclosure, the connection housing unit can advantageously be adapted to an air flow generated by the fan, which air flow comprises a component parallel to the rotation axis and a component around the rotation axis. In particular, the air may form an advantageously stable vortex about the rotation axis. In particular, a deflection of the air flow can advantageously be kept small. In particular, a probability of occurrence of localized vortices can advantageously be kept small. In particular, a risk of material depositing in lower-flow portions of the fan receiving region can advantageously be kept low. In particular, advantageously effective elimination of the removed material can be achieved. In particular, a maintenance and cleaning interval of the hand-held grinding machine can advantageously be kept large.

It is furthermore proposed that the connection housing unit comprises a conical spiral path arranged on the inner wall, which path in particular leads from an air inlet, in particular the already mentioned air inlet, of the connection housing unit in the direction of the rotation axis to an injection port, in particular the already mentioned ejection port, of the connection housing unit. It is conceivable that the hand-held grinding machine in an alternative design is designed independently of the funnel-shaped design of the fan receiving region. Preferably, the hand-held grinding machine comprises, in the alternative design, in particular in the design independent of the funnel-shaped design of the fan receiving region, at least the grinding device for receiving or forming the grinding means, wherein the grinding device comprises at least the fan for transporting away material removed during a grinding operation, the drive device for driving the grinding device, and the connection housing unit, which at least partially receives the grinding device. In particular, the receiving radius depends on its angular position with respect to a rotation about the rotation axis, at least in the region of the spiral path. The conical spiral path is in particular a surface delimited by at least one conical spiral, preferably by a conical spiral and a concentric circular arc concentric to the conical spiral. The angular position relates in particular to an angle that is in a plane perpendicular to the rotation axis. In particular, the receiving radius is a function of an angular difference of the angular position of the receiving radius from an angle reference. In particular, the angle reference is arranged at the orifice location, in particular at a separating edge, which the ejection port forms with the inner wall of the connection housing unit. Preferably, the receiving radius in the region of the spiral path has the lowest value at the separating edge. Preferably, the receiving radius in the region of the spiral path increases monotonically, optionally strictly monotonically, starting from the separating edge around the rotation axis, in particular in a viewing direction toward the grinding pad in the clockwise or counterclockwise direction. Preferably, in a projection along the rotation axis, the spiral path has the shape of an arithmetic spiral, alternatively of a logarithmic spiral, a hyperbolic spiral, or another spiral shape. Preferably, the spiral path comprises less than one turn. Preferably, the spiral path comprises more than a quarter of a turn, in particular a half of a turn or more. In particular, the spiral path extends from the separating edge in a direction facing away from the orifice, to a start of the orifice opposite the separating edge. For example, in a half-shell design of the connection housing unit, the spiral path can be designed in only one or in both main shells of the connection housing unit. A product consisting of a pitch of the spiral path and a number of turns of the spiral path corresponds at least substantially, in particular to more than ⅓, preferably to more than ⅔, to a maximum extension of the blades of the fan parallel to the rotation axis. In particular, the spiral path extends in a direction parallel to the rotation axis at least starting from a terminating plane of the blades facing the grinding pad, to the orifice. As a result of the design according to the disclosure, a movement of the air flow away from the grinding pad in the direction of the rotation axis can advantageously be supported. In particular, a vortex formation around the rotation axis to the orifice can advantageously be supported.

It is furthermore proposed that the inner wall be segmented in the direction of the rotation axis, wherein an orifice, in particular the already mentioned orifice, of an ejection port of the connection housing unit and an air inlet, in particular the already mentioned air inlet, of the connection housing unit are arranged in different segments of the inner wall. It is conceivable that the hand-held grinding machine in an alternative design is designed independently of the funnel-shaped design of the fan receiving region and/or the conical spiral path. Preferably, the hand-held grinding machine comprises, in the alternative design, in particular in the design independent of the funnel-shaped design of the fan receiving region and/or the conical spiral path, at least the grinding device for receiving or forming the grinding means, wherein the grinding device comprises at least the fan for transporting away material removed during a grinding operation, the drive device for driving the grinding device, and the connection housing unit, which at least partially receives the grinding device. The orifice is in particular arranged in an ejection segment of the connection housing unit. The inner wall in the ejection segment preferably extends at least substantially perpendicularly to the rotation axis. Preferably, the connection housing unit comprises at least one guide segment arranged in the direction of the rotation axis between the ejection segment and the bottom portion. The guide segment in particular forms the conical spiral path. The inner wall in the guide segment in particular extends at an acute angle to the rotation axis. Preferably, the connection housing unit comprises at least one further guide segment arranged between the guide segment and the bottom portion. In particular, the inner wall in a further guide segment has an angle to the rotation axis that is greater than the angle of the guide segment to the rotation axis. As a result of the design according to the disclosure, the inner wall can advantageously be precisely adapted to a geometry of the fan. In particular, a distance of the inner wall from the fan and in particular a flow resistance can advantageously be precisely defined by the connection housing unit. In particular, a main flow direction through the connection housing unit can be defined. In particular, local vortex formation can advantageously be kept low. In particular, the connection housing unit can advantageously be kept compact.

Furthermore, it is proposed that a separating edge formed by an orifice, in particular the already mentioned orifice, of an ejection port, in particular the already mentioned ejection port, of the connection housing unit, hereinafter referred to as a further separating edge for the purpose of distinction, extends at least substantially perpendicularly to the rotation axis. In particular, the further separating edge separates the guide segment from the ejection segment. Preferably, in a plane parallel to the rotation axis, the further separating edge has a material-side angle that is obtuse, in particular of more than 100°, preferably of more than 110°, particularly preferably of more than 115°. In a plane substantially perpendicular to the rotation axis, the further separating edge preferably curves around the rotation axis, in particular in the shape of a circular arc. Preferably, the further separating edge is arranged in a plane that extends between the terminating plane of the blades and the base plate of the fan. Alternatively, the further separating edge is arranged in the terminating plane of the blades or between the terminating plane and the grinding pad. As a result of the design according to the disclosure, a proportion of the removed material that has a velocity component in a direction facing away from the grinding pad can advantageously be filtered out. In particular, the material discharged through the ejection port has an advantageously high homogeneous velocity distribution. In particular, a risk of material depositing on an inner wall of the ejection port can advantageously be kept low.

Furthermore, it is proposed that a separating edge that is formed by an orifice, in particular the already mentioned orifice, of an ejection port, in particular the already mentioned ejection port, of the connection housing unit and is at least substantially parallel to the rotation axis, in particular the already mentioned separating edge, is designed to be tapered to a point and to have a radius of curvature of less than 10 mm. Preferably, the radius of curvature is less than 3 mm, particularly preferably less than 2 mm. Preferably, the radius of curvature is greater than 1 mm. The radius of curvature of the separating edge is in particular in a plane at least substantially perpendicular to the rotation axis. The radius of curvature of the separating edge describes, in particular independently of an exact shaping of the separating edge, a smallest imaginary circle that touches both the inner wall facing the fan and an inner wall of the ejection port. Preferably, tangents touching the inner wall and the inner wall of the ejection port enclose an angle of between 45° and 65°, preferably between 55° and 60°, in a plane perpendicular to the rotation axis. As a result of the design according to the disclosure, the air flow can advantageously be effectively guided into the ejection port. In particular, an average dwell time of the material in the fan receiving region can advantageously be kept short.

In addition, it is proposed that at least one segment of the inner wall that forms a spiral path, in particular the already mentioned spiral path, in particular the guide segment, has an angle between 15° and 60°, in particular between 20° and 40°, to the rotation axis. Preferably, the guide segment has an angle of between 30° and 35° to the rotation axis. The further guide segment preferably has an angle between 50° and 75°, preferably between 55° and 65°, to the rotation axis. In particular, the guide segment comprises a base edge that faces the grinding pad and adjoins the further guide segment. Preferably, the base edge extends in a plane at least substantially parallel to the rotation axis. Preferably, the base edge is arranged circularly around the rotation axis. Preferably, the guide segment comprises a guide edge that faces the drive device. A distance of the guide edge to the base edge, in particular parallel to the rotation axis and perpendicular to the rotation axis, depends on the angular position of a point on the guide edge. In particular, the distance between the guide edge and the base edge increases in the circumferential direction with respect to the rotation axis. In particular, a surface arranged between the guide edge and the base edge forms the conical spiral path. As a result of the design according to the disclosure, a flow fraction perpendicular to the rotation axis can advantageously be kept low. In particular, an advantageously stable vortex formation can be achieved around the rotation axis and in parallel to the rotation axis.

Furthermore, it is proposed that a channel longitudinal axis of an ejection port, in particular the already mentioned ejection port, of the connection housing unit is oriented at an acute angle to a longitudinal axis of the drive device in a plane perpendicular to the rotation axis. In particular, the longitudinal axis extends at least substantially perpendicularly to the rotation axis. In particular, in the direction of the longitudinal axis, the drive device, and in particular the entire hand-held grinding machine, has a maximum longitudinal extension that is greater than a total height of the drive housing parallel to the rotation axis. The longitudinal axis and the rotation axis in particular span a mounting plane in which mounting half shells of the drive housing and/or of the connection housing unit are arranged on one another. In a plane perpendicular to the rotation axis, the channel longitudinal axis has in particular an acute angle to the longitudinal axis, in particular to the mounting plane, that is in particular between 30° and 60°, preferably between 40° and 50°, particularly preferably between 44° and 46°. Preferably, in a plane perpendicular to the rotation axis, the channel longitudinal axis tangentially touches an outer contour of the fan. In particular, in a tangent plane of an outer contour of the fan, the channel longitudinal axis extends in a plane perpendicular to the rotation axis. Preferably, an inner wall of the ejection port in the orifice region tangentially continues the spiral path and transitions smoothly into a path parallel to the channel longitudinal axis. As a result of the design according to the disclosure, an inertia of the air flow rotating about the rotation axis and of the removed material can advantageously be used to eject them out of the ejection port. In particular, a flow resistance of the ejection port can advantageously be kept small and an advantageously high efficiency of the fan can be achieved. In addition, a material collection container attached to the collection port can advantageously be arranged spaced apart from the drive housing.

It is furthermore proposed that a channel longitudinal axis, in particular the already mentioned channel longitudinal axis, of an ejection port, in particular the already mentioned ejection port, of the connection housing unit encloses an acute angle with a plane perpendicular to the rotation axis. In particular, the acute angle between the channel longitudinal axis and the plane perpendicular to the rotation axis is more than 10°, preferably more than 15°, particularly preferably more than 20°. Preferably, the acute angle between the channel longitudinal axis and the plane perpendicular to the rotation axis is less than 50°, in particular less than 40°, preferably less than 35°. The ejection port in particular comprises an ejection opening for ejecting the removed material. The channel longitudinal axis preferably extends at least substantially perpendicularly to the ejection opening. Optionally, the ejection port flattens in the region of the orifice so that at the orifice, a wall of the ejection channel facing the grinding pad has a larger angle to the plane perpendicular to the rotation axis than the channel longitudinal axis has. As a result of the design according to the disclosure, a movement of the air flow and of the removed material in parallel to the rotation axis can advantageously be used to eject them out of the ejection port. In particular, a flow resistance of the ejection port can advantageously be kept small and an advantageously high efficiency of the fan can be achieved. In addition, a material collection container attached to the collection port can advantageously be arranged spaced apart from the grinding pad and in particular from a workpiece treated with the hand-held grinding machine, so that the hand-held grinding machine can advantageously be used flexibly, in particular even on uneven or difficult-to-access surfaces.

It is furthermore proposed that the connection housing unit comprises at least two main shells, which at least partially encompass the fan in a mounting plane parallel to the rotation axis, in particular the already mentioned mounting plane. In particular, the air inlet is smaller than a maximum transverse extension of the blades perpendicular to the rotation axis. Preferably, the bottom portion is arranged between the blades and the grinding pad. Preferably, the further guide segment is arranged at least partially between the fan and the grinding pad. Preferably, the fan is arranged between the bottom portion and an upper side of the connection housing unit facing the drive housing. In particular, the upper side and the bottom portion are integrally formed and in particular encompass the fan in a U-shape from a direction perpendicular to the rotation axis. As a result of the design according to the disclosure, the fan receiving region can advantageously be precisely defined and a pressure drop across the fan can advantageously be precisely designed. In particular, the fan can advantageously be operated efficiently. In particular, an air flow of an advantageously high flow velocity can be achieved. In particular, the connection housing unit can advantageously be assembled quickly. In particular, a number of individual parts that the air flow may potentially cause to move relative to one another or to vibrate can advantageously be kept low.

In addition, it is proposed that the fan is designed asymmetrically to form a transmission element of the grinding device. In particular, the fan forms an eccentric of the grinding device for driving the grinding pad. In particular, the fan comprises a base plate, in particular a solid disk-shaped base plate to which the blades of the fan are fastened. The base plate preferably faces the drive device. The blades of the fan preferably face the grinding pad. In particular, the fan comprises, as an eccentric, a central shaft that is surrounded by the blades in a plane perpendicular to the rotation axis. In particular, the central shaft is arranged eccentrically to the base plate on the base plate. The drive shaft is in particular connected to the eccentric in rotationally fixed manner. Preferably, the fan has at least one fan counterweight, which is arranged within the blades. Preferably, the base plate of the fan has a lowered portion, which is arranged at an offset from the remaining base plate in the direction of the rotation axis. The lowered portion is in particular semi-annular. The lowered portion and the fan counterweight, in particular together with a portion of the blades, are preferably arranged on the lowered portion. A maximum extension of the blades at the lowered portion parallel to the rotation axis is preferably smaller than a maximum extension of the remaining portion of the blades parallel to the rotation axis, in particular so that all blades of the fan have the common terminating plane perpendicular to the rotation axis. As a result of the design according to the disclosure, the grinding device can advantageously be designed to be compact and have few components. In particular, an advantageously low maximum extension of the grinding device and of the connection housing unit parallel to the rotation axis can be achieved.

Furthermore, it is proposed that blades, in particular the already mentioned blades, of the fan have chamfers arranged transversely to the rotation axis and at least substantially in parallel to a segment of the inner wall, in particular the further guide segment. The term “substantially (in) parallel” is in particular intended here to be understood to mean an orientation of a direction relative to a reference direction, in particular in a plane, wherein the direction has a deviation from the reference direction of in particular less than 8°, advantageously less than 5°, and particularly advantageously less than 2°. In particular, the blades taper in a direction pointing in the direction of the rotation axis. In particular, a maximum extension of a portion of the blades facing the inner wall in a direction parallel to the rotation axis is smaller than the maximum extension of a portion of the blades facing the rotation axis. Preferably, the base plate has an edge region, in particular an annular edge region, that is inclined in the direction of the grinding pad, in particular in the opposite direction to the chamfer. The chamfer preferably has an angle between 50° and 75°, preferably between 55° and 65°, to the rotation axis. As a result of the design according to the disclosure, an advantageously high flow velocity through the fan can be maintained. In particular, a static pressure between the fan and the inner wall can advantageously be kept low.

The hand-held grinding machine according to the disclosure is not to be limited to the above-described application and embodiment. In order to fulfill a functionality described herein, the hand-held grinding device according to the disclosure can in particular comprise a number of individual elements, components, and units that deviates from a number mentioned herein. Moreover, in the case of the value ranges specified in this disclosure, values within the mentioned limits are also to be considered as disclosed and usable as desired.

The disclosure relates to a hand-held grinding machine with at least one grinding device for receiving or forming a grinding means, with a drive device for driving the grinding device, with a drive housing receiving the drive device, and with an interface device for operatively connecting the grinding device to the drive device, wherein the interface device comprises at least one connection housing unit, formed separately from the drive housing and the grinding device, for at least partially receiving the grinding device, and a docking interface arranged on the drive housing, wherein the connection housing unit encompasses the docking interface in a fixing plane perpendicular to a rotation axis of a drive shaft of the drive device.

It is proposed that the docking interface in the fixing plane comprises at least one axial form-fit element, which is in particular designed as a fixing recess and/or an oblique or concave surface, for forming a form fit, parallel to the rotation axis, with the connection housing unit, wherein a projection of the axial form-fit element along the rotation axis is at least substantially completely in the interior of the drive housing. The hand-held grinding machine can preferably be held with one hand, in particular without a transport and/or holding device, and in particular be guided and operated by the same hand during a grinding operation. The hand-held grinding machine may be designed as a random orbit sander, a positively driven random orbit sander, an oscillating sander, a triangular sander, a polisher, or the like. The grinding means can, for example, be designed as a sand paper, as a sanding sponge, as an abrasive nonwoven fabric, as an abrasive fabric, as a polishing sponge, as an abrasive disk, as a buffing wheel, or the like. In particular, the grinding device comprises at least one grinding pad with a planar base surface, which is in particular at least substantially parallel to the fixing plane and which is provided for fastening the grinding means. The term “provided” is understood in particular to mean specifically configured, specifically programmed, specifically designed, and/or specifically equipped. An object being provided for a particular function is understood in particular to mean that the object fulfills and/or performs this particular function in at least one application state and/or operating state. The term “substantially (in) parallel” is in particular intended here to be understood to mean an orientation of a direction relative to a reference direction, in particular in a plane, wherein the direction has a deviation from the reference direction of in particular less than 8°, advantageously less than 5°, and particularly advantageously less than 2°.

The drive device preferably comprises an electric motor, in particular a brushless DC motor, for driving the drive shaft, in particular about the rotation axis common to the electric motor and the drive shaft. The drive device in particular comprises a control electronics for controlling or regulating the electric motor. Preferably, the drive device comprises at least one electrical supply interface for supplying energy to the electric motor. Particularly preferably, the electrical supply interface is designed to receive a battery that is non-destructively detachable from the drive device and/or a non-destructively detachable storage battery, in particular a battery pack. Alternatively or additionally, the electrical supply interface comprises a wired, inductive or capacitive charging element for supplying an internal energy store of the drive device.

The drive housing preferably comprises a longitudinal axis that is at least substantially perpendicular to the rotation axis. Preferably, a maximum longitudinal extension of the drive housing parallel to, in particular along, the longitudinal axis is greater than a total height of the drive housing parallel to, in particular along, the rotation axis. Along the longitudinal axis, the drive housing in particular comprises a longitudinal axis portion, in which the electrical supply interface is arranged, and a front portion, in which the drive shaft is arranged. The docking interface is in particular arranged on the front portion along the rotation axis. Preferably, a maximum extension of a cross section of the longitudinal axis portion perpendicular to the longitudinal axis is less than the total height of the drive housing, in particular so that the longitudinal axis portion, the front portion and the docking interface form an L-shaped structure in a mounting plane. The mounting plane is in particular spanned by the longitudinal axis and by the rotation axis.

The interface device is preferably provided to provide a standardized connection for the drive device and the grinding device so that the drive device and the grinding device can in particular be designed and/or pre-assembled independently of one another. For example, a structurally identical or analog interface device in a further hand-held power tool connects a grinding device structurally identical to that of the hand-held power tool, to a drive device of a different performance class than that of the hand-held power tool. For example, a structurally identical or analog interface device of an alternative hand-held power tool connects a different grinding device than that of the hand-held power tool to a drive device structurally identical to that of the hand-held power tool. In particular, application-dependent transmission elements for specifying a path of the grinding pad and/or application-dependent fastening elements for fastening the grinding pad relative to the drive housing are designed as part of the grinding device or the interface device. In particular, the connection housing unit depends on a design of the grinding device. Preferably, the docking interface is designed independently of a design of the grinding device and independently of a performance class of the drive device. The docking interface is preferably formed in one piece with the drive housing. The term “in one piece” is in particular to be understood to mean shaped in one piece. Preferably, this one piece is produced from a single blank, a mass and/or a cast, particularly preferably in a pressing method, a die-casting method, or an injection-molding method, in particular a single- and/or multi-component injection-molding method. Alternatively, the docking interface is formed separately from the drive housing and fastened to the drive housing. Preferably, the docking interface encompasses the drive shaft in the fixing plane. Preferably, the fixing plane intersects the drive shaft. Alternatively, the drive shaft is recessed along the rotation axis relative to the docking interface so that the fixing plane does not intersect the drive shaft. The term “for operatively connecting” is to be understood in particular to mean a connection that allows a transfer of mechanical work, for example by means of a clutch, by means of an eccentric transmission, by means of a worm gear, by means of a gear transmission, and/or by means of a different transmission element. Preferably, the interface device comprises at least one transmission element for indirectly or directly transferring a movement of the drive shaft to the grinding pad. The transmission element of the interface device is preferably pressed onto the drive shaft and/or engaged in the drive shaft. Alternatively, the transmission element of the interface device is formed in one piece with the drive shaft. Preferably, the grinding device is formed separately from the transmission element and fastened, in particular screwed to, pressed onto, and/or engaged in, the transmission element. Alternatively, the transmission element of the interface device is formed in one piece with a transmission element of the grinding device.

The connection housing unit is in particular provided to surround an intermediate space between the docking interface and the grinding pad, in which space a transmission of the grinding device, a fan of the grinding device, or the like, is arranged, for example. In particular, on a side facing the grinding pad, the connection housing unit has a groove for fastening a slip ring of the grinding device. By means of the axial form-fit element, the connection housing unit is arranged on the docking interface immovably relative to the drive housing, in particular apart from a material elasticity of the connection housing unit, the docking interface, and/or the drive housing. The docking interface and the axial form-fit element are provided in particular for a form-fitting and optionally force-fitted connection of the connection housing unit to the drive housing. Particularly preferably, the connection housing unit comprises at least two main shells, which are arranged on one another, in particular in the mounting plane. In particular, the main shells each partially, in particular halfway, encompass the docking interface in the fixing plane from different sides of the docking interface. Preferably, the main shells are formed as mounting half shells. In particular, the connection housing unit is arranged directly on the docking interface, in particular on an exterior of the docking interface pointing away from the rotation axis. Preferably, the main shells encapsulate the docking interface. Preferably, at least a volume fraction of more than 50%, in particular more than 75%, particularly preferably more than 95%, of the docking interface is in the interior of the connection housing unit. In particular, the connection housing unit is arranged in the fixing plane around the docking interface in an angular range relative to the rotation axis of more than 180°, preferably more than 270°, particularly preferably more than 355°. Optionally, the connection housing unit comprises further housing elements formed separately from the main shells. Preferably, the main shells are fastened to the docking interface and optionally to one another by means of the axial form-fit element. Particularly preferably, the axial form-fit element includes a subregion of the connection housing unit parallel to the rotation axis in the interior of a base body of the docking interface and/or clamps a subregion of the connection housing unit between the docking interface and the drive housing. Alternatively, the docking interface comprises a structural element that projects into a wall of the connection housing unit.

Preferably, the docking interface comprises at least two, in particular two differently designed, axial form-fit elements. Preferably, the docking interface comprises at least one pair of identically designed axial form-fit elements, which are arranged in particular on different sides of a plane that comprises the rotation axis and is in particular perpendicular to the mounting plane. Particularly preferably, the entire docking interface is designed to be mirror-symmetrical with respect to the plane that is perpendicular to the mounting plane and comprises the rotation axis. In particular, the mounting plane intersects the axial form-fit element, in particular each of the axial form-fit elements. Particularly preferably, the projections of all axial form-fit elements of the docking interface along the rotation axis are at least substantially completely in the interior of the drive housing. In particular, a projection of the entire docking interface along the rotation axis is at least substantially completely in the interior of the drive housing. The term “substantially completely” is in particular to be understood to mean at least 60%, preferably at least 80%, and particularly preferably at least 95% with respect to a maximum extension and/or a maximum surface area of the projection. Particularly preferably, in a projection along the rotation axis, an outer contour of the axial form-fit element, in particular of the entire docking interface, has a minimum distance in the interior of the drive housing to an outer contour of the drive housing of at least 3%, preferably more than 5%, with respect to a maximum extension of the projection.

As a result of the design according to the disclosure, an advantageously secure connection can be established between the drive housing and the connection housing unit. In particular, a relative movement of the drive housing and the connection housing unit can advantageously be kept low. In particular, the connection housing unit is advantageously stably connected to the drive housing unit even if it absorbs a force and/or a torque, for example by a hand or by additional components arranged on the connection housing unit, for example a material collection container. Furthermore, a transition between the drive housing and the connection housing can advantageously be designed to be small so that a hand placed on the connection housing unit can advantageously comfortably encompass the transition. In particular, an advantageously high ease of use can be achieved.

Furthermore, it is proposed that the docking interface comprises, as an axial form-fit element, a fixing recess, in particular a fixing recess that extends at least substantially in parallel to the fixing plane, and in particular a fixing recess that is provided to receive a fixing element of the connection housing unit and/or a separately formed fixing element. The fixing element of the connection housing unit is preferably formed integrally with one of the main shells and is in particular designed as a structural element projecting from a contact surface of these main shells, for example as a pin, as a bar, as a catch tongue, or the like. The separately formed fixing element is, for example, designed as a screw, a rivet, a threaded rod, a latch, or the like. The docking interface preferably comprises the base body, which is in particular solid. The fixing recess preferably extends into the base body of the docking interface, and particularly preferably through the base body of the docking interface, in a direction at least substantially perpendicular to the rotation axis, in particular to the mounting plane. Alternatively, the fixing recess is designed as a blind hole, a groove, or the like. The term “substantially perpendicular” is to be understood here in particular to mean an orientation of a direction relative to a reference direction, wherein the direction and the reference direction, in particular as viewed in a projection plane, enclose an angle of 90°, and the angle has a deviation of in particular less than 8°, advantageously less than 5°, and particularly advantageously less than 2°. The base body preferably completely encompasses the fixing recess in the mounting plane. Alternatively, the base body encompasses the fixing recess in the mounting plane in a U-shape, for example, and in particular forms a mounting shaft that leads to the fixing recess and in particular extends in the fixing plane. Preferably, the docking interface comprises at least two, in particular structurally identical, fixing recesses, which are arranged in the mounting plane on different sides of the rotation axis. As a result of the design according to the disclosure, a form fit in both directions along the rotation axis can advantageously be achieved simply. In particular, the drive housing and the connection housing unit are advantageously firmly connected to one another. In particular, a number of fixing elements for the connection housing unit on an outside of the connection housing unit can advantageously be kept low. In particular, an advantageously large surface for placing a hand can be provided by the connection housing unit.

It is furthermore proposed that the connection housing unit comprises at least two main shells, in particular the already mentioned main shells, at least one of which comprises a fixing element designed as a sleeve, in particular a fixing element that is designed as a sleeve for receiving a separately formed fixing element, wherein a total receiving length of the sleeve substantially corresponds to a length of the separately formed fixing element. Preferably, the sleeve is connected to at least one of the main shells in a material fit. Particularly preferably, the sleeve comprises two separately formed sleeve portions, one of which is arranged on each of the main shells. In particular, the pair of sleeve portions are oriented along a fixing axis on one another so that the separate fixing element engages simultaneously through both sleeve portions along the fixing axis. The sleeve is preferably arranged in the fixing recess of the docking interface. Alternatively, the sleeve is arranged outside the docking interface. The expression that a quantity “substantially corresponds to a comparative quantity” is to be understood in particular to mean that the quantity corresponds to more than 25%, preferably more than 50%, particularly preferably more than 75% of the comparative quantity. Preferably, the total receiving length of the sleeve for receiving the fixing element is shorter than the length of the fixing element. Particularly preferably, the sleeve portions are arranged spaced apart from one another along the fixing axis. In particular, one of the sleeve portions forms a blind hole, while the other sleeve portion is tubular. Alternatively, both sleeve portions are tubular. Optionally, at least one of the sleeve portions forms a thread and/or a catch recess and/or comprises an embedded nut or another counterpart to the separately formed fixing element. Alternatively, a counterpart to the separately formed fixing element is arranged on an outside of the docking interface. As a result of the design according to the disclosure with main shells, the connection housing unit can advantageously be easily assembled. In particular, in addition to an axial form fit, the main shells can advantageously be clamped to the docking interface so that an additional form fit and/or force fit can be achieved at least substantially in parallel to the rotation axis. Furthermore, by limiting the total receiving length, a fastening of the main shells to one another under tension can be achieved so that an advantageously close abutment of the main shells on the docking interface, an advantageously high force fit of the main shells with the docking interface, and an advantageously small play of the main shells relative to the docking interface can be achieved.

Furthermore, it is proposed that the docking interface as an axial form-fit element has a docking cross section perpendicular to the rotation axis that tapers along the rotation axis in a direction pointing away from the grinding device. Preferably, the docking cross section tapers continuously in the direction of the rotation axis over a portion that at least substantially corresponds to a docking height of the docking interface, that in particular includes more than 80% of the docking height of the docking interface. In particular, on a side facing the drive housing, the docking cross section has the least extension parallel to the fixing plane. In particular, on a side facing away from the drive housing, the docking cross section has the largest extension parallel to the fixing plane. In particular, the axial form-fit element is designed as a contact surface of the docking interface that faces the drive housing, in particular faces away from the rotation axis. Preferably, the contact surface is annular, wherein a geometric central axis of the contact surface is in particular aligned coaxially with the rotation axis. In particular, an inner wall of the housing connection unit is arranged on the contact surface of the docking interface. Particularly preferably, a passage of the housing connection unit for receiving the drive shaft and/or the transmission element of the interface device has a maximum opening width parallel to the fixing plane that is smaller than the maximum extension of the docking interface parallel to the fixing plane. In particular, on an axis parallel to the rotation axis, the housing connection unit is arranged between the drive housing and the docking interface, in particular the contact surface. Preferably, a maximum extension of the docking cross section, in particular a largest outer diameter of the docking interface, is at least 10%, preferably more than 25%, particularly preferably more than 33% greater than a minimum extension, in particular a smallest outer diameter, of the docking cross section parallel to the fixing plane. Preferably, a smallest imaginary trapezoid, which just completely surrounds the docking cross section of the docking interface, has an acute internal angle between base and leg of between 20° and 70°, preferably between 40° and 50°. As a result of the design according to the disclosure, an advantageously large contact surface of the docking interface for the connection housing unit can be achieved, which can be used as a clamping surface, in particular in interaction with the fixing element, when the connection housing unit is assembled. In particular, an advantageously large overlap can be achieved between the connection housing unit and the docking interface.

In addition, it is proposed that the docking interface comprises, as an axial form-fit element, an oblique and/or curved contact surface, in particular the already mentioned contact surface, that is transverse to the fixing plane and is designed to be complementary to a mating surface of the connection housing unit, in particular an oblique and/or curved mating surface. In particular, the contact surface, and in particular also the mating surface, intersects the fixing plane at an acute angle, in particular between 10° and 80°, preferably between 20° and 70°. In a curved design, the contact surface is preferably concave relative to the rotation axis. In particular, a radius of curvature describing the concave contact surface is outside the docking interface. Alternatively, the contact surface is convex relative to the rotation axis. In particular, a radius of curvature describing the convex contact surface intersects the docking interface. In particular, the contact surface comprises at least one contact surface portion, which is formed in a circular arc in a plane, in particular each plane, containing the rotation axis. Preferably, at least one tangent plane of the contact surface has an angle of less than 20°, preferably less than 15°, to the rotation axis, wherein said tangent plane optionally has an angle of more than 5°, in particular more than 10°, to the rotation axis. In particular, at least one further tangent plane of the contact surface has an angle of more than 90°, preferably more than 100°, particularly preferably more than 105°, to the rotation axis, wherein said tangent plane optionally has an angle of less than 150°, in particular less than 125°, to the rotation axis. In particular, a central angle of at least 35°, preferably at least 45°, in particular more than 55°, around a center of curvature associated with the radius of curvature corresponds to an extension of the circular arc-shaped contact surface portion. Preferably, the contact surface terminates in the direction of the grinding device with a planar contact portion arranged tangentially on the curved contact portion of the contact surface. Preferably, a circular arc-shaped extension of the contact surface is longer, in particular at least twice longer, preferably more than three times longer than its tangential continuation in the planar contact portion. As a result of the design according to the disclosure, the connection housing unit can advantageously be designed to be compact. In particular, an advantageously large distance of the connection housing unit from the longitudinal axis portion of the drive housing can be achieved, in particular so that re-gripping of the longitudinal axis portion with one hand close to the rotation axis is advantageously possible. Furthermore, advantageously, a hand placed on the connection housing unit can also advantageously be placed between the longitudinal axis portion and the connection housing unit. In particular, an advantageously high number of gripping positions is provided by the connection housing unit.

In addition, it is proposed that the radius of curvature is between 5 mm and 15 mm. Preferably, the radius of curvature is greater than 7 mm, particularly preferably greater than 9 mm. Preferably, the radius of curvature is less than 12 mm, particularly preferably less than 10 mm. Preferably, a ratio of the radius of curvature to the docking height of the docking interface parallel to the rotation axis is greater than 0.5, preferably greater than 0.7, particularly preferably greater than 0.8. Preferably, the ratio of the radius of curvature to the docking height of the docking interface parallel to the rotation axis is less than 1.5, preferably less than 1.2, particular preferably less than 0.9. As a result of the design according to the disclosure, the contact surface can advantageously be designed to be compact and with a large surface area at the same time.

It is furthermore proposed that the docking interface, in particular the contact surface, comprises at least 10% to 20%, in particular between 13% and 17%, of a total height of the drive housing, including the docking interface, parallel to the rotation axis. In an alternative design, the docking interface, in particular the contact surface, comprises between 5% and 10% or between 20% and 40% of a total height of the drive housing, including the docking interface, parallel to the rotation axis. As a result of the design according to the disclosure, an advantageously stable connection between the drive housing and the connection housing unit can be achieved.

It is furthermore proposed that the docking interface in the fixing plane encompasses a bearing element of the drive device, in particular a bearing element of the drive device that is configured to rotatably mount a transmission element, in particular the already mentioned transmission element, of the interface device and/or the drive shaft. Preferably, the bearing element is designed as a ball bearing, alternatively as a slide bearing. Preferably, the bearing element is arranged in the fixing plane between the fixing recesses of the docking interface. In particular, the fixing plane intersects the connection housing unit and the bearing element. Particularly preferably, the transmission element encompasses the drive shaft in the fixing plane. Optionally, on a side facing the electric motor, the transmission element has a larger cross section perpendicular to the rotation axis than in the fixing plane, in particular a larger cross section than an opening width of the bearing element, for receiving the bearing element. The docking interface preferably comprises a groove in which the bearing element is inserted or embedded. Alternatively, the drive shaft is in direct contact with the bearing element and in particular protrudes beyond the bearing element in the direction of the grinding device. As a result of the design according to the disclosure, a total height of the drive housing, in particular of the entire hand-held grinding machine, can advantageously be kept low. In particular, a fixed point of the rotation axis can advantageously be defined relative to the drive housing and relative to the connection housing unit at the same time.

It is furthermore proposed that the docking interface has, as an axial form-fit element, a smaller cross section at a boundary surface, at least substantially perpendicular to the rotation axis, to the drive housing than the drive housing so that the connection housing unit can be arranged on the docking interface at least substantially flush with the drive housing. The term “substantially flush” is to be understood in particular to mean an offset of less than 1 mm, preferably less than 0.75 mm, particularly preferably less than 0.5 mm. Preferably, the drive housing together with the docking interface forms a shoulder at the boundary surface. In particular, at the boundary surface, the drive housing comprises a bottom surface that is at least substantially parallel to the fixing plane and protrudes at the boundary surface perpendicularly to the rotation axis beyond the docking interface in a manner corresponding to a material thickness of the housing connection unit. In particular, the housing connection unit is arranged on the shoulder and, in particular, continues a contour of the drive housing without a shoulder. As a result of the design according to the disclosure, a form fit can advantageously be achieved in a direction opposite to that defined by the contact surface. In particular, an axial position of the connection housing unit relative to the drive housing can be defined along the rotation axis with an advantageously low error tolerance. In particular, a risk of a compensation movement of the connection housing unit in the direction of the drive housing, for example when the fixing element is fastened and/or when the hand-held grinding machine pushes on a workpiece, can advantageously be kept low.

It is furthermore proposed that the connection housing unit comprises at least two main shells, in particular the already mentioned main shells, which are aligned with one another in the fixing plane by means of at least one tongue-and-groove connection, which is in particular oblique or curved. In particular, one of the main shells comprises at least one groove and the other main shell comprises at least one spring in the fixing plane, which are arranged on one another in the mounting plane. Preferably, the main shells each have at least one tongue-and-groove connection in the fixing plane on different sides of the rotation axis. In particular, the tongue-and-groove connection is arranged in a curved contact portion of the main shells. The curved contact portion of the main shells in particular forms the mating surface that is complementary to the contact surface. Preferably, the contact portion comprises a curved outer surface facing away from the mating surface. An outer radius of curvature is smaller than the radius of curvature of the contact surface and is in particular arranged outside the main shell. In particular, the main shells comprise a planar tangential portion which tangentially continues the curved contact portion beyond the docking interface. Preferably, the tongue-and-groove connection is arranged in a transition region between the tangential portion and the contact portion of the main shells. Preferably, a ratio of a transverse extension of the tongue-and-groove connection, parallel to a material thickness of the main shells, to the material thickness of the main shells is greater than 0.15, preferably greater than 0.2, in particular greater than 0.25. Preferably, the transverse extension of the tongue-and-groove connection is between 0.5 mm and 1.5 mm, particularly preferably between 0.75 mm and 1 mm. Optionally, the connection housing unit comprises an elastic sealing element between the main shells. The tongue-and-groove connection is preferably convex, alternatively concave, with respect to the rotation axis. In particular, a connecting surface of the tongue-and-groove connection is at least substantially parallel to the mating surface of the connection housing unit. As a result of the design according to the disclosure, an additional mutual form fit parallel to the rotation axis and a friction fit in the fixing plane of the main shells can advantageously be achieved. In particular, the main shells can advantageously be easily arranged precisely on one another. In particular, the main shells, in particular in contrast to a rabbet, can advantageously be arranged under tension by means of the fixing element.

Furthermore, it is proposed that a drive fan of the drive device and a fan of the grinding device are arranged along the rotation axis on different sides of the axial form-fit element. In particular, the drive fan is designed as a motor fan. The drive fan is in particular provided for cooling the electric motor. In particular, the fan is arranged within the connection housing unit. Preferably, the drive fan is arranged in the drive housing. Preferably, the docking interface is arranged between the drive fan and the fan. Preferably, the docking interface delimits a receiving space of the drive housing for the drive fan. Preferably, the docking interface delimits a fan receiving region of the connection housing unit for the fan. In particular, the drive fan and the fan are arranged at ends of the transmission element of the interface device facing away from one another. In particular, the transmission element projects into the receiving space for the drive fan and into the fan receiving region for the fan. The transmission element of the interface device is in particular provided to drive the fan. The transmission element of the interface device is in particular provided to support an axial position of the drive fan along the drive shaft. As a result of the design according to the disclosure, the docking interface and in particular the drive device can advantageously be designed independently of the specific grinding device. In particular, the docking interface can be designed independently of a dimensioning of the grinding device, in particular of the fan. In particular, the docking interface can be utilized in addition to a fluidic separation of the drive fan and the fan so that the hand-held grinding machine can advantageously be designed to be compact.

In addition, the disclosure relates to a method for assembling a hand-held grinding machine with at least one grinding device for receiving or forming a grinding means, with a drive device for driving the grinding device, which device is arranged in at least one method step in a drive housing of the hand-held grinding machine, and with an interface device for operatively connecting the grinding device to the drive device, wherein the interface device comprises at least one connection housing unit, formed separately from the drive housing and the grinding device, in which unit the grinding device is arranged at least partially in at least one method step, and a docking interface arranged on the drive housing, wherein the connection housing unit is arranged to encompass the docking interface in at least one method step in a fixing plane perpendicular to a rotation axis of a drive shaft of the drive device. It is proposed that, in at least one method step, in which a form fit of the connection housing unit parallel to the rotation axis with the docking interface is formed by means of an axial form-fit element of the docking interface, which element is arranged in the fixing plane and is in particular designed as a fixing recess and/or an oblique or concave surface, wherein a projection of the axial form-fit element along the rotation axis is at least substantially completely in the interior of the drive housing. In at least one method step, the transmission element of the interface unit is preferably pressed onto the drive shaft of the drive device, which is in particular pre-assembled. In at least one method step, the grinding device, which is in particular pre-assembled, is preferably fastened, in particular screwed, to the transmission element. In at least one method step, one of the main shells is preferably arranged on the docking interface. In particular, the mating surface is arranged on the contact surface. In particular, the sleeve portion of the main shell is inserted into the fixing recess of the docking interface. Preferably, in at least one method step, a further one of the main shells is arranged on the docking interface; in particular, the main shells are arranged on one another in the mounting plane and are in particular aligned with one another by means of the tongue-and-groove connection. The mating surface of the further one of the main shells is in particular arranged on the contact surface. The sleeve portion of the further one of the main shells is inserted into the fixing recess. In particular, in at least one method step, the separately formed fixing element is inserted, pressed or screwed through one of the main shells, the sleeve and the docking interface into a further one of the main shells. As a result of the design according to the disclosure, a hand-held grinding machine can advantageously be produced in a modular fashion and can advantageously be easily assembled. In particular, a high degree of flexibility can be achieved in a combination of a drive device, in particular a standardized one, and one of different grinding devices. In particular, despite the modular design, an advantageously high stability of the hand-grinding machine can be achieved.

The grinding machine according to the disclosure and/or the method according to the disclosure is/are not intended to be limited to the above-described application and embodiment. In particular, for fulfilling a functionality described herein, the grinding machine according to the disclosure and/or the method according to the disclosure can comprise a number of individual elements, components, units, and method steps that deviates from a number mentioned herein. Moreover, in the case of the value ranges specified in this disclosure, values within the mentioned limits are also to be considered as disclosed and usable as desired.

The disclosure relates to a hand-held grinding machine with at least one grinding device for receiving or forming a grinding means, with a drive device for driving the grinding device, with at least one actuating element for controlling the drive device, and with a drive housing which receives the drive device and has a longitudinal axis portion, which is arranged about a longitudinal axis at least substantially perpendicular to a rotation axis of the drive device, and comprises a front portion, which surrounds an intersection region of the rotation axis and of the longitudinal axis.

It is proposed that the front portion comprises a dome-shaped gripping surface within which the actuating element is arranged on a side, facing away from the longitudinal axis portion, of a plane perpendicular to the longitudinal axis and comprising the rotation axis. The hand-held grinding machine can preferably be held with one hand, in particular without a transport and/or holding device, and in particular be guided and operated by the same hand during a grinding operation. The hand-held grinding machine may be designed as a random orbit sander, a positively driven random orbit sander, an oscillating sander, a triangular sander, a polisher, or the like. The grinding means can, for example, be designed as a sand paper, as a sanding sponge, as an abrasive nonwoven fabric, as an abrasive fabric, as a polishing sponge, as an abrasive disk, as a buffing wheel, or the like. In particular, the grinding device comprises at least one grinding pad with a planar base surface, which is in particular at least substantially perpendicular to the rotation axis and which is provided for fastening the grinding means. The term “provided” is understood in particular to mean specifically configured, specifically programmed, specifically designed, and/or specifically equipped. An object being provided for a particular function is understood in particular to mean that the object fulfills and/or performs this particular function in at least one application state and/or operating state. The term “substantially perpendicular” is to be understood here in particular to mean an orientation of a direction relative to a reference direction, wherein the direction and the reference direction, in particular as viewed in a projection plane, enclose an angle of 90°, and the angle has a deviation of in particular less than 8°, advantageously less than 5°, and particularly advantageously less than 2°.

The drive device preferably comprises an electric motor, in particular a brushless DC motor, for driving a drive shaft of the drive device about the rotation axis common to the electric motor and the drive shaft. The grinding device is preferably arranged on the drive shaft directly or indirectly on a drive of the grinding pad. The drive device in particular comprises a control electronics for controlling or regulating the electric motor. Preferably, the drive device comprises at least one electrical supply interface for supplying energy to the electric motor. Particularly preferably, the electrical supply interface is designed to receive a battery that is non-destructively detachable from the drive device and/or a non-destructively detachable storage battery, in particular a battery pack. Alternatively or additionally, the electrical supply interface comprises a wired, inductive or capacitive charging element for supplying an internal energy store of the drive device. The actuating element is in particular provided for activating or deactivating the drive device. Preferably, the actuating element is designed as a switch that can be locked in an activated state of the drive device. Alternatively, the actuating element is designed as a pushbutton.

Preferably, a maximum longitudinal extension of the drive housing in the direction of the longitudinal axis is greater than a maximum extension of the drive housing in the direction of the rotation axis. For the purpose of distinction, the maximum extension of the drive housing in the direction of the rotation axis is hereinafter referred to as the total height of the drive housing. Optionally, the hand-held grinding machine comprises a connection housing unit in which the grinding device is at least partially arranged. The design of the connection housing unit is in particular dependent on a design of the grinding device. The total height of the drive housing relates in particular to a housing part of the hand-held grinding machine that is independent of the specific design of the grinding device and in particular does not take into account the connection housing unit of the grinding device. In an integral design of the drive housing with the connection housing unit of the grinding device, a separation plane, perpendicular to the rotation axis, between the drive housing and the connection housing unit, from which the total height is measured, is defined by an end of the drive shaft facing the grinding device. The electrical supply interface and/or the control electronics is preferably arranged in the longitudinal axis portion of the drive housing. The electric motor and drive shaft are preferably arranged in the front portion. The grinding device is in particular arranged on the front portion in the direction of the rotation axis. Preferably, a maximum extension of a cross section of the longitudinal axis portion perpendicular to the longitudinal axis is less than the total height of the drive housing parallel to the rotation axis, in particular so that the longitudinal axis portion, the front portion and the grinding device form an L-shaped structure, in particular in a mounting plane. The mounting plane is in particular spanned by the longitudinal axis and by the rotation axis. Preferably, the drive housing comprises two drive housing half shells, which are arranged on one another in the mounting plane and in particular each form half of the longitudinal axis portion and of the front portion. Preferably, the front portion is connected in a material fit to the longitudinal axis portion, in particular produced as a cast or in a pressing process. Particularly preferably, the drive housing is produced by an injection-molding method, in particular a single- and/or multi-component injection-molding method, or by a die-casting method.

The dome-shaped gripping surface in particular has a convexly curved surface with respect to the rotation axis and/or the longitudinal axis. The dome-shaped gripping surface has an ellipsoidal outer contour, in particular on sides facing away from the grinding device and/or the longitudinal axis portion. In particular, the dome-shaped gripping surface has a sectionally and/or partially oval-shaped outer contour in the mounting plane. Preferably, the dome-shaped gripping surface comprises a further sectionally and/or partially oval-shaped outer contour in a plane perpendicular to the rotation axis. Preferably, the dome-shaped gripping surface has an additional sectionally and/or partially oval-shaped outer contour in a plane perpendicular to the longitudinal axis. In particular, the dome-shaped gripping surface has a greater maximum transverse extension in a plane perpendicular to the longitudinal axis than a parallel maximum transverse extension of the longitudinal axis portion. In particular, in a plane perpendicular to the longitudinal axis, the dome-shaped gripping surface has two maximum transverse extensions perpendicular to one another, both of which are greater than a respectively parallel maximum transverse extension of the longitudinal axis portion. Particularly preferably, in a projection along the longitudinal axis, an outer contour of the longitudinal axis portion is completely in the interior of the outer contour of the front portion. In particular, the dome-shaped gripping surface is provided for re-gripping with one hand. In particular, the gripping surface defines the region provided for re-gripping with the hand. Optionally, the gripping surface is formed from a soft component, which is connected to the drive housing half shells by means of a multi-component spraying method, for example, or which is formed separately and fastened to the drive housing half shells by means of catch protrusions, for example. In particular, the gripping surface is arranged on an outside of the drive housing half shells. Alternatively, the gripping surface is formed by a surface of the drive housing half shells. In particular, the gripping surface extends in a plane that is perpendicular to the longitudinal axis and in particular comprises the rotation axis, and, with respect to an intersection point of the rotation axis and the longitudinal axis, by an angular range of more than 180°, preferably more than 220°, particularly preferably by more than 250°, about the intersection point, in particular on an outside of the drive housing half shells. Preferably, the gripping surface extends over at least 50%, preferably more than 60%, preferably more than 75% of an outer contour of the drive housing half shells in the plane that is perpendicular to the longitudinal axis and in particular comprises the rotation axis. In particular, the gripping surface extends in a plane that is perpendicular to the rotation axis and in particular comprises the rotation axis, and, with respect to the intersection point of the rotation axis and the longitudinal axis, by an angular range of more than 120°, preferably more than 160°, particularly preferably by more than 180°, about the intersection point, in particular on an outside of the drive housing half shells. Preferably, the gripping surface extends over at least 10%, preferably more than 20%, of an outer contour of the drive housing half shells in the plane that is perpendicular to the rotation axis and in particular comprises the rotation axis. Preferably, the gripping surface extends over less than 75%, preferably less than 50%, of an outer contour of the drive housing half shells in the plane that is perpendicular to the rotation axis and in particular comprises the rotation axis. In particular, the gripping surface extends in the mounting plane with respect to the intersection point of the rotation axis and the longitudinal axis by an angular range of more than 160°, preferably more than 180°, particularly preferably by more than 200°, about the intersection point, in particular on an outside of the drive housing half shells. Preferably, the gripping surface extends over at least 10%, preferably more than 20%, particularly preferably over more than 30%, of an outer contour of the drive housing half shells in the mounting plane. Preferably, the gripping surface extends over less than 80%, preferably less than 60%, of an outer contour of the drive housing half shells in the mounting plane. Preferably, a plane perpendicular to the longitudinal axis can be arranged between the actuating element and the electric motor and does not intersect the actuating element or the electric motor, in particular at least does not intersect a stator coil or a magnet of the electric motor. Preferably, the mounting plane intersects the actuating element, in particular centrally. Particularly preferably, the mounting plane is a mirror symmetry plane for the actuating element.

As a result of the design according to the disclosure, an advantageously ergonomic hand-held grinding machine can be provided. In particular, an advantageously safe guidance of the hand-held grinding machine can be achieved by gripping around the front portion with one hand. In particular, as a result of the dome-shaped design, the hand-held grinding machine can be held securely with one hand with an advantageously small force. In particular, actuation of the actuating element can advantageous take place without gripping with the index finger and/or middle finger, and in particular without using a second hand. In particular, physical stress due to a grinding operation performed with the hand-held grinding machine can advantageously be kept low. In particular, a risk of injury due to a use, in particular long-lasting and/or frequent use, of the hand-held grinding machine can advantageously be kept low.

It is furthermore proposed that the actuating element is arranged, in particular embedded, in a partial surface of the gripping surface that is arranged obliquely to the longitudinal axis and the rotation axis. The partial surface in which the actuating element is arranged is preferably arranged on a side of the drive housing facing away from the grinding device. Preferably, the gripping surface is flattened around the actuating element. In particular, the partial surface surrounding the actuating element is at least sectionally planar in the mounting plane. In particular, the partial surface in which the actuating element is arranged has an angle in the mounting plane of between 35° and 50°, particularly preferably between 40° and 45°, to the longitudinal axis. Preferably, in an activated state of the hand-held grinding machine, the actuating element is arranged flush with the partial surface surrounding the actuating element or is arranged recessed with respect thereto into an internal space of the front portion. Preferably, a curvature of the actuating element in a plane perpendicular to the rotation axis is adapted to a curvature of the gripping surface in said plane. Preferably, in a direction perpendicular to the rotation axis and the longitudinal axis, the actuating element occupies less than half of a maximum extension of the partial surface surrounding the actuating element. Preferably, in parallel to the longitudinal axis, the actuating element occupies less than half, preferably less than a quarter, of a maximum gripping-surface longitudinal extension of the gripping surface. A machine terminating plane that is parallel to the rotation axis and comprises the point of the drive housing furthest from the grinding pad is preferably arranged spaced apart from the actuating element. As a result of the design according to the disclosure, the actuating element can advantageously be actuated with a single finger, in particular without having to loosen a grip around the gripping surface with the hand. An advantageously high work safety can be achieved.

It is furthermore proposed that the partial surfaces of the gripping surfaces that terminate the front portion along the longitudinal axis and one of which surrounds the actuating element are arranged at a front angle between 95° and 110° to one another. Particularly preferably, the front angle is between 98° and 102°. The front angle is in particular in the mounting plane. Preferably, the partial surfaces having the front angle are on different sides of a transverse plane perpendicular to the rotation axis. The partial surface that does not comprise the actuating element is in particular arranged facing the grinding device and has an angle in the mounting plane of between 30° and 55°, preferably between 45° and 50°, to the longitudinal axis. A transition between the partial surfaces that terminate the front portion along the longitudinal axis is in particular rounded. Preferably, a volume of the electric motor is arranged largely, in particular to more than 50%, particularly more than 75%, on a side of the transverse plane facing the grinding device. As a result of the design according to the disclosure, the gripping surface can advantageously be securely held without strong curvature of the fingers. In particular, a risk of the fingers cramping due to a longer grinding process can advantageously be kept low.

It is furthermore proposed that the actuating element and the grinding device are arranged on different sides of a transverse plane at least substantially perpendicular to the rotation axis, in particular the already mentioned transverse plane, in which the front portion has the largest gripping-surface transverse extension, which is at least substantially perpendicular to the rotation axis and at least substantially perpendicular to the longitudinal axis. In particular, the largest gripping-surface transverse extension is the largest transverse extension of the entire drive housing perpendicular to the longitudinal axis and the rotation axis. In particular, a ratio of the largest gripping-surface transverse extension to a total height of the drive housing, particularly without the connection housing unit, is between 0.75 and 1, preferably between 0.8 and 0.95, particularly preferably between 0.85 and 0.9. In particular, the largest gripping-surface transverse extension is between 65 mm and 85 mm, preferably between 70 mm and 80 mm, particularly preferably between 72 mm and 76 mm. As a result of the design according to the disclosure, a provided ergonomic hand position for forming a form fit with the hand-held grinding machine and a secure guidance of the hand-held grinding machine can advantageously be intuitively imparted in that an advantageously natural hand position with the thumb and index fingers on different sides of the transverse plane is in particular supported.

In addition, it is proposed that a ratio of a maximum gripping-surface height of the gripping surface parallel to the rotation axis to a parallel total height of the drive housing is between 0.65 and 0.8, preferably between 0.7 and 0.75. The drive device preferably comprises a drive fan, in particular a motor fan, in particular for cooling the electric motor. The drive housing comprises at least one ventilation opening for exhausting and/or taking in air by means of the drive fan. In particular, the drive fan and the ventilation openings are arranged between the electric motor and the grinding device. Preferably, the gripping surface extends in a direction of the rotation axis from the ventilation openings to the machine terminating plane. In particular, the gripping surface extends in a direction of the rotation axis over an at least substantially entire length, in particular over more than 50%, preferably over more than 75%, particularly preferably over at least 90% of the entire length, of the electric motor parallel to the rotation axis. As a result of the design according to the disclosure, an advantageously compact hand-held grinding machine can be provided. In particular, a separate gripping region, which is designed in addition to a motor cover, can be omitted. In particular, a hand-held grinding machine can be provided that allows an advantageously high user comfort for an advantageously large range of hand sizes and finger lengths.

It is furthermore proposed that the drive housing has a protuberance on both sides in a plane perpendicular to the rotation axis and comprising the longitudinal axis, wherein a ratio of a maximum protuberance transverse extension from protuberance to protuberance of the drive housing to a largest gripping-surface transverse extension, in particular the already mentioned gripping-surface transverse extension, of the front portion is between 0.75 and 0.9, particularly preferably between 0.8 and 0.85. It is conceivable that the hand-held grinding machine in an alternative design is designed independently of the dome-shaped gripping surface. Preferably, the hand-held grinding machine comprises, in the alternative design, in particular in the design designed independently of the dome-shaped gripping surface, at least the grinding device for receiving or forming the grinding means, the drive device for driving the grinding device, the actuating element for controlling the drive device, and the drive housing which receives the drive device and has the longitudinal axis portion, which is arranged about the longitudinal axis at least substantially perpendicular to the rotation axis of the drive device, and comprises the front portion, which surrounds the intersection region of the rotation axis and of the longitudinal axis. In particular, the maximum protuberance transverse extension is between 50 mm and 74 mm, preferably between 55 mm and 70 mm, particularly preferably between 58 mm and 64 mm. Preferably, the protuberances, in particular the maximum protuberance transverse extension, are in the same plane as the largest gripping-surface transverse extension, i.e., in the transverse plane. Alternatively, the maximum protuberance transverse extension is arranged in a plane that is at least substantially perpendicular to the rotation axis and extends in a direction of the rotation axis, in particular spaced apart from the transverse plane. Preferably, the protuberances are formed and/or arranged in a mirror-symmetrical manner to the mounting plane. Alternatively, the protuberances are arranged at an offset from one another in a direction of the longitudinal axis and/or in a direction of the rotation axis and/or are designed to be of different sizes. Particularly preferably, twice a radius of curvature of the protuberances in a plane that is perpendicular to the rotation axis and in particular comprises the maximum protuberance transverse extension corresponds to between 50% and 150%, preferably between 75% and 125%, particularly preferably between 90% and 110%, of the maximum protuberance transverse extension. Preferably, twice a further radius of curvature of the protuberances in a plane that is perpendicular to the longitudinal axis and in particular comprises the maximum protuberance transverse extension is smaller than the maximum protuberance transverse extension and is in particular between 0% and 75%, preferably between 5% and 50%, particularly preferably between 10% and 20%, of the maximum protuberance transverse extension. The protuberances are preferably connected to the remaining drive housing without edges and without shoulders. In particular, a cross section of the drive housing comprising the protuberances is oval-shaped perpendicularly to the longitudinal axis. In particular, an outer contour of a cross section that perpendicular to the rotation axis and has the protuberances is sinusoidal. As a result of the design according to the disclosure, a support surface for a finger, in particular for a thumb and/or a small finger, can advantageously be provided and a risk of a hand sliding in the direction of the longitudinal axis can be prevented. In particular, the correct position of the hand on the gripping surface can be checked by an operator without having to look at the hand-held grinding machine.

Furthermore, it is proposed that a gripping surface, in particular the already mentioned gripping surface, of the drive housing transitions smoothly starting from the front portion in a direction of the longitudinal axis into a tapering region of the longitudinal axis portion delimited by the protuberances, wherein a ratio of a maximum taper transverse extension of the tapering region to a largest gripping-surface transverse extension, in particular the already mentioned largest gripping-surface transverse extension, of the front portion is between 0.7 and 0.85, preferably between 0.75 and 0.8. In particular, the taper transverse extension is between 50 mm and 65 mm, preferably between 55 mm and 60 mm. In particular, the maximum taper transverse extension is perpendicular to the longitudinal axis and perpendicular to the rotation axis. Preferably, the maximum taper transverse extension is in the transverse plane, which in particular also comprises the maximum gripping-surface transverse extension. Preferably, the control electronics is arranged in the tapering region. Preferably, the control electronics is arranged in the tapering region on a side of the transverse plane facing away from the grinding device. Preferably, a further maximum transverse extension of the tapering region parallel to the rotation axis is at most 98%, preferably less than 95%, particularly preferably less than 93%, of a maximum transverse extension of the longitudinal axis portion parallel to the rotation axis. In particular, a concave part of the tapering portion facing the machine terminating plane has a radius of curvature that is greater than, in particular more than twice, the maximum transverse extension of the longitudinal axis portion parallel to the rotation axis. Preferably, a transition between the tapering region and the front portion is formed without shoulders and without steps. In particular, the drive housing continuously tapers from the front portion to a minimum in the tapering region along the longitudinal axis. As a result of the design according to the disclosure, a finger depression can advantageously be realized on the hand-held grinding device so that an advantageously intuitive arrangement of a hand on the gripping surface is enabled. In particular, spreading of the hand in order to the gripping surface can advantageously be avoided. In particular, a high, effective contact surface can be achieved between the gripping surface and one hand, in particular with an advantageously low degree of curvature of the fingers and with an advantageously low amount of force.

In addition, it is proposed that a gripping surface, in particular the already mentioned gripping surface, of the drive housing extends from the front portion to a plane that is perpendicular to the longitudinal axis and intersects the protuberances. In particular, the gripping surface extends to a plane that is perpendicular to the longitudinal axis and comprises the maximum protuberance transverse extension. Optionally, the gripping surface extends beyond the protuberances in the direction of an end of the drive housing facing away from the front angle. In particular, a maximum gripping-surface longitudinal extension of the gripping surface parallel to the longitudinal axis is greater than the maximum gripping-surface height. Preferably, the gripping-surface longitudinal extension on a part of the gripping surface facing the machine terminating plane is longer than a part of the gripping surface facing the grinding device. Preferably, the gripping-surface longitudinal extension increases in parallel to the rotation axis, in particular starting at the ventilation openings in the direction of the machine terminating plane. Preferably, the gripping-surface height parallel to the rotation axis is greater in the front portion than in the tapering region and/or in the plane intersecting the protuberance. Preferably, the gripping-surface height decreases along the longitudinal axis, in particular starting from the front portion to the protuberances. Preferably, the protuberances are arranged outside the gripping surface. As a result of the design according to the disclosure, an advantageously large gripping surface can be provided.

Furthermore, it is proposed that a plane that is perpendicular to the longitudinal axis and intersects the protuberances divides a maximum longitudinal extension of the drive housing in a ratio of between 0.45 and 0.65. Preferably, the protuberances are arranged in a plane perpendicular to the longitudinal axis with the electrical supply interface and/or the control electronics. In particular, a ratio of the maximum gripping-surface longitudinal extension to the maximum longitudinal extension of the drive housing without an energy store connected to the electrical supply interface is between 0.55 and 0.60. Preferably, a ratio of the maximum gripping-surface longitudinal extension to the maximum longitudinal extension of the drive housing, including an energy store arranged on the electrical supply interface, is between 0.5 and 0.55. As a result of the design according to the disclosure, an advantageously good balance can be achieved between the drive device and the grinding device. In particular, the grinding device can be displaced across a surface with advantageously little force.

Furthermore, it is proposed that the hand-held grinding machine comprises a material collection container arranged in a plane perpendicular to the rotation axis and spaced apart from the drive housing, in particular the gripping surface, wherein in at least one configuration, a container longitudinal axis of the material collection container is at least substantially parallel to the longitudinal axis. The term “substantially (in) parallel” is in particular intended here to be understood to mean an orientation of a direction relative to a reference direction, in particular in a plane, wherein the direction has a deviation from the reference direction of in particular less than 8°, advantageously less than 5°, and particularly advantageously less than 2°. In particular, the material collection container is fastened to the connection housing unit. In particular, the material collection container is not fastened to the drive housing. In particular, the material collection container is arranged spaced apart from the drive housing. Preferably, a minimum distance between the drive housing, in particular from one of the protuberances, and the material collection container is at least 10 mm, preferably more than 15 mm, in particular more than 20 mm. Preferably, the minimum distance between the drive housing, in particular one of the protuberances, and the material collection container is less than 40 mm, in particular less than 30 mm. As a result of the design according to the disclosure, the connection housing unit can advantageously be utilized as a further hand resting surface. In particular, an intermediate space for placing a second hand between the drive housing and the grinding device can be advantageously large, in particular with the same or an even smaller maximum extension of the hand-held grinding machine parallel to the rotation axis.

It is furthermore proposed that the hand-held grinding machine comprises an operating element for controlling the grinding device and a material collection container, in particular the already mentioned material collection container, wherein the operating element and the material collection container are arranged on different sides of a mounting plane spanned by the rotation axis and the longitudinal axis. In particular, the operating element is formed separately from the actuating element. In particular, the operating element is provided for adjusting an operating parameter of the drive device, for example a rotation rate of the drive shaft. The operating element is preferably arranged in the tapering portion. Preferably, the operating element is arranged between the transverse plane and the grinding pad. Alternatively, the operating element is arranged in the transverse plane. The operating element is provided in particular for operation with a thumb when the index finger and middle finger are arranged in the front portion, in particular on the partial surface surrounding the actuating element. As a result of the design according to the disclosure, the hand-held grinding machine can advantageously be operated easily by one hand. In particular, a movement space for a finger actuating the operating element can advantageously be kept large and is in particular not restricted by the material collection container.

The hand-held grinding machine according to the disclosure is not to be limited to the above-described application and embodiment. In order to fulfill a functionality described herein, the hand-held grinding device according to the disclosure can in particular comprise a number of individual elements, components, and units that deviates from a number mentioned herein. Moreover, in the case of the value ranges specified in this disclosure, values within the mentioned limits are also to be considered as disclosed and usable as desired.

### BRIEF DESCRIPTION OF THE DRAWINGS

Further advantages become apparent from the following description of the drawings. Four exemplary embodiments of the disclosure are illustrated in the drawings. The drawings, the description and the claims contain numerous features in combination. The person skilled in the art will expediently also consider the features individually and combine them to form further meaningful combinations.

The figures show:

FIG. 1a schematic perspective representation of a material collection device according to the disclosure,

FIG. 2a schematic perspective representation of a hand-held power tool according to the disclosure with the material collection device according to the disclosure,

FIG. 3a schematic plan view of the hand-held power tool according to the disclosure,

FIG. 4a schematic longitudinal section of the hand-held power tool according to the disclosure,

FIG. 5a schematic cross section of the hand-held power tool according to the disclosure,

FIG. 6a schematic representation of a fastening of a connection housing unit of the hand-held power tool according to the disclosure,

FIG. 7a schematic cross section of the connection housing unit,

FIG. 8a schematic longitudinal section of a material collection device of the hand-held power tool according to the disclosure,

FIG. 9a schematic flow diagram of a method according to the disclosure for assembling the hand-held power tool according to the disclosure,

FIG. 10a schematic representation of an alternative design of a hand-held power tool according to the disclosure with an alternative drive device,

FIG. 11a schematic longitudinal section of the alternative design,

FIG. 12a schematic representation of a further alternative design of a hand-held power tool according to the disclosure with an alternative grinding device,

FIG. 13a schematic longitudinal section of the further alternative design,

FIG. 14a schematic representation of an additional alternative design of a hand-held power tool according to the disclosure with a further alternative grinding device, and

FIG. 15a schematic longitudinal section of the additional alternative design.

### DETAILED DESCRIPTION

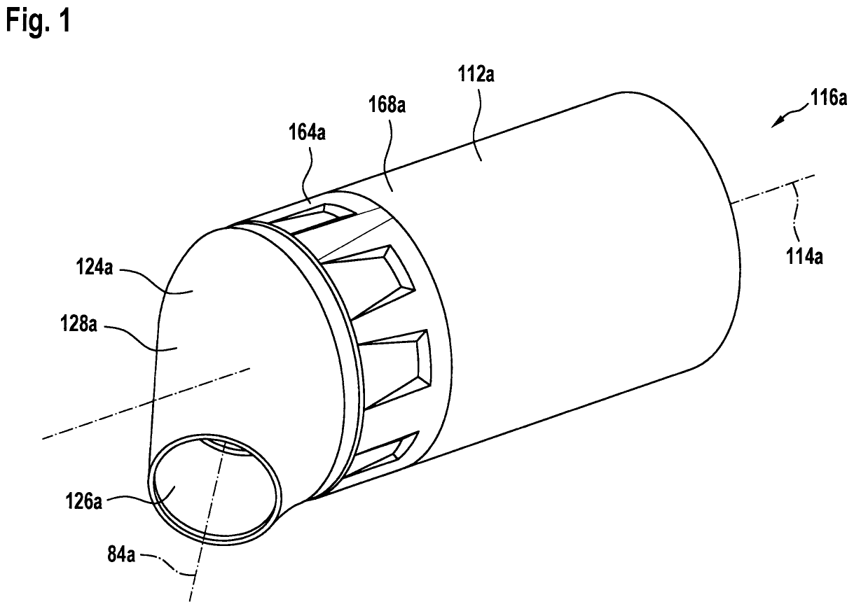

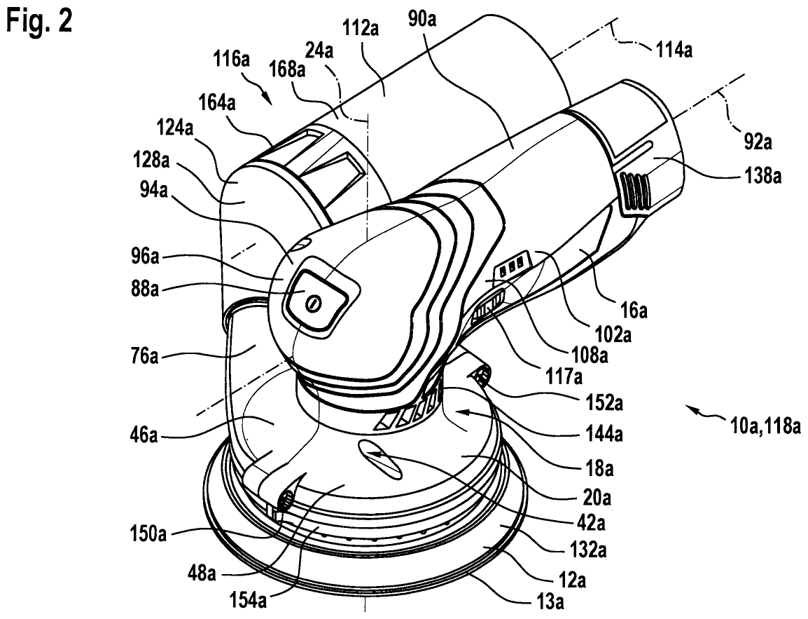

FIG. 1 shows a material collection device 116a for a hand-held power tool 118a (see FIG. 2). The material collection device 116a in particular comprises a material collection container 112a. The material collection container 112a is preferably cylindrical. The material collection device 116a in particular comprises a mounting unit 124a. The mounting unit in particular comprises an adapter housing 128a and a channel element 126a arranged in the adapter housing 128a.

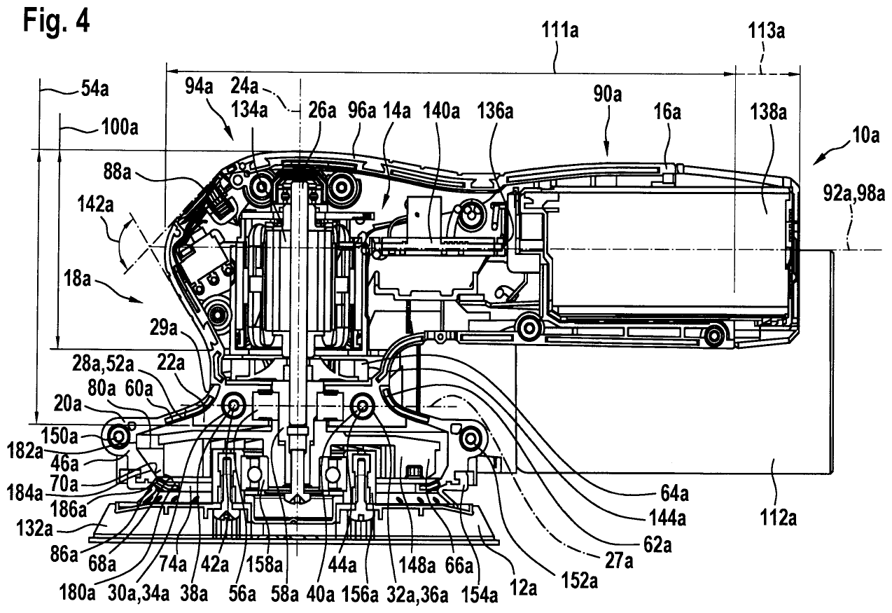

FIG. 2 shows, by way of example, a hand-held power tool 118a designed as a hand-held grinding machine 10a. The hand-held power tool 118a is in particular designed as a random orbit sander. The hand-held power tool 118a comprises, in particular as a tool device, a grinding device 12a for receiving or forming a grinding means 13a. The grinding device 12a in particular comprises a grinding pad 132a, which is shown here, by way of example, with a diameter of 125 mm. Alternatively, the grinding pad 132a has a diameter of 150 mm or another diameter adapted to a size of the grinding means 13a. The hand-held power tool 118a comprises a drive device 14a, in particular for driving the grinding device 12a (see FIG. 4), which in particular defines a rotation axis 24a about which the grinding pad 132a can be driven, in particular eccentrically. The hand-held power tool 118a comprises a drive housing 16a receiving the drive device 14a.

The drive housing 16a has a longitudinal axis 92a that is at least substantially perpendicular to the rotation axis 24a. Preferably, the drive housing 16a comprises two drive housing half shells, which are arranged on one another in a mounting plane 50a spanned by the longitudinal axis 92a and the rotation axis 24a (cf. FIG. 2). The drive housing 16a comprises a longitudinal axis portion 90a arranged about the longitudinal axis 92a. The longitudinal axis portion 90a is in particular provided for receiving a battery pack 138a, in particular a 12-volt battery pack. The drive housing 16a comprises a front portion 94a. The front portion 94a surrounds an intersection region of the rotation axis 24a and the longitudinal axis 92a. The front portion 94a comprises a dome-shaped gripping surface 96a. Optionally, the gripping surface 96a is designed as a soft component, which is arranged on, in particular embedded in, a housing base body of the drive housing 16a. Alternatively, an outer surface of the housing base body of the drive housing 16a forms the gripping surface 96a. The hand-held power tool 118a comprises at least one actuating element 88a for controlling the drive device 14a, in particular for switching the drive device 14a on and off. Preferably, the actuating element 88a is designed to catch in an activated state of the drive device 14a. The actuating element 88a is arranged in the gripping surface 96a. The actuating element 88a is arranged on a side, facing away from the longitudinal axis portion 90a, of a plane perpendicular to the longitudinal axis 92a and comprising the rotation axis 24a.

The hand-held power tool 118a comprises an interface device 18a, particularly a clutch, for operatively connecting the grinding device 12a to the drive device 14a. The interface device 18a is in particular arranged along the rotation axis 24a on the front portion 94a. The interface device 18a comprises at least one connection housing unit 20a for at least partially receiving the grinding device 12a. The connection housing unit 20a is formed separately from the drive housing 16a and the grinding device 12a. The connection housing unit 20a comprises at least two half shells 46a, 48a. The main shells 46a, 48a are in particular arranged on one another in the mounting plane 50a. The main shells 46a, 48a are preferably made of plastic. Preferably, the main shells 46a, 48a have a wall thickness of between 1 mm and 3.5 mm, preferably between 1.5 mm and 2.5 mm, particularly preferably between 1.9 mm and 2.3 mm. The connection housing unit 20a comprises an ejection port 76a. The ejection port 76a is in particular provided for ejecting material abraded during a grinding process, from the connection housing unit 20a. The ejection port 76a is preferably arranged on one of the main shells 46a. The hand-held power tool 118a comprises a material collection device 116a. The material collection device 116a comprises the material collection container 112a, which is in particular air-permeable, for collecting material removed by the hand-held power tool 118a and in particular ejected via the ejection port 76a, such as in particular dust, chips, and/or abraded material. In at least one configuration of the material collection container 112a, a container longitudinal axis 114a of the material collection container 112a extends at least substantially in parallel to the longitudinal axis 92a of the drive housing 16a. The container longitudinal axis 114a is in particular designed as a container center axis, which in particular passes through a geometric center of gravity of the material collection container 122a.

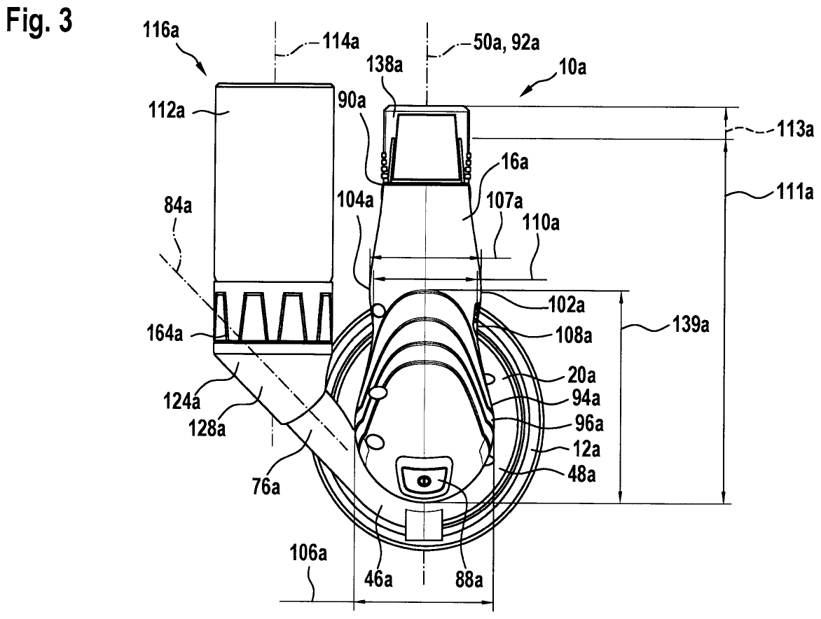

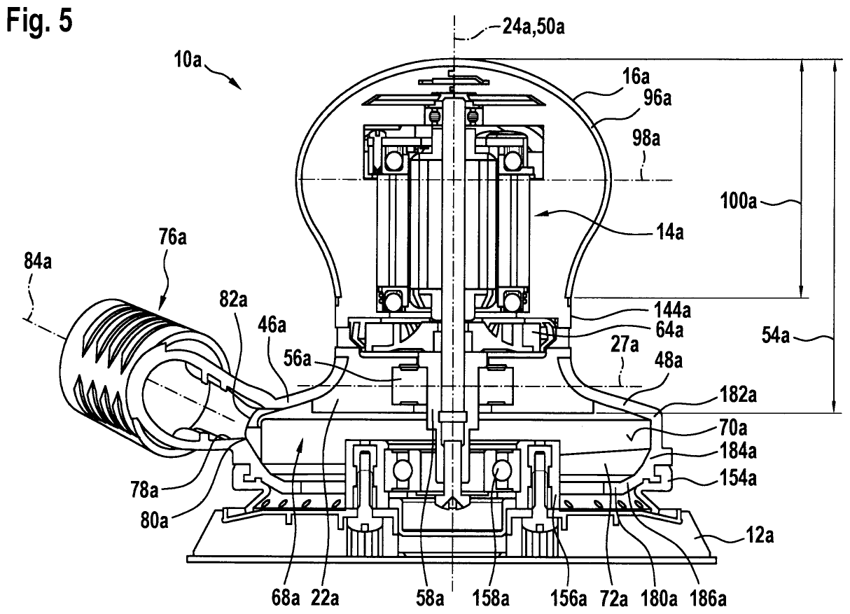

FIG. 3 shows a view of the hand-held power tool 118a along the rotation axis 24a. The drive housing 16a has a protuberance 102a, 104a on both sides in a plane perpendicular to the rotation axis 24a and comprising the longitudinal axis 92a. A ratio of a maximum protuberance transverse extension 107a from protuberance 102a to protrusion 104a of the drive housing 16a to a largest gripping-surface transverse extension 106a of the front portion 94a is between 0.75 and 0.9, in particular between 0.80 and 0.85. Preferably, the largest gripping-surface transverse extension 106a is also the largest transverse extension of the drive housing 16 perpendicular to the rotation axis 24a and perpendicular to the longitudinal axis 92a. A ratio of the largest gripping-surface transverse extension 106a to a total height 54a (cf. FIGS. 4 and 5) of the drive housing 16a is preferably between 0.8 and 0.95, in particular between 0.85 and 0.9. Preferably, the largest gripping-surface transverse extension 106a is between 65 mm and 85 mm, in particular between 70 mm and 80 mm. In particular, the total height 54a of the drive housing 16a parallel to the rotation axis 24a is less than 95 mm, preferably less than 90 mm, in particular less than 85 mm. Particularly preferably, a maximum machine height parallel to the rotation axis 24a of the hand-held power tool 118a is less than 115 mm, in particular less than 110 mm.

The gripping surface 96a of the drive housing 16a transitions smoothly starting from the front portion 94a in the direction of the longitudinal axis 92a into a tapering region 108a of the longitudinal axis portion 90a delimited by the protuberances 102a, 104a. A ratio of a maximum taper transverse extension 110a of the tapering region 108a to the largest gripping-surface transverse extension 106a of the front portion 94a is between 0.7 and 0.85, in particular between 0.75 and 0.8. The gripping surface 96a of the drive housing 16a extends from the front portion 94a to a plane that is perpendicular to the longitudinal axis 92a and intersects the protuberances 102a, 104a. Optionally, the gripping surface 96a extends along the longitudinal axis 92a beyond the protuberances 102a, 104a. A plane that is perpendicular to the longitudinal axis 92a and intersects the protuberances 102a, 104a divides a maximum longitudinal extension 111a, 113a of the drive housing 16a in a ratio of between 0.45 and 0.65. In particular, a ratio of a protuberance position 139a of the plane intersecting the protuberances 102a, 104a, along the longitudinal axis 92a starting from a remotest point of the front portion 94a to the maximum longitudinal extension 111a without battery pack 138a is between 0.55 and 0.60. In particular, a ratio of a protuberance position 139a of the plane intersecting the protuberances 102a, 104a, along the longitudinal axis 92a starting from a remotest point of the front portion 94a to the maximum longitudinal extension 113a, including battery pack 138a, is between 0.5 and 0.55. In particular, the maximum longitudinal extension 111a, 113a parallel to, in particular along, the longitudinal axis 92a is greater than the total height 54a of the drive housing 16a.

The material collection container 112a is arranged spaced apart from the gripping surface 96a of the drive housing 16a in a plane perpendicular to the rotation axis 24a. In particular, the material collection container 112a is arranged on the ejection port 76a by means of the mounting unit 124a of the material collection device 116a, in particular in a freely suspended manner and in particular without further support elements. A transition between the mounting unit 124a and the material collection container 112a is arranged with the tapering region 108a in a plane perpendicular to the longitudinal axis 92a. A channel longitudinal axis 84a of the ejection port 76a of the connection housing unit 20a is oriented at an acute angle, in particular between 40° and 50°, preferably between 44° and 46°, to the longitudinal axis 92a in a plane perpendicular to the rotation axis 24a. The channel longitudinal axis 84a is preferably designed as a channel center longitudinal axis, which in particular passes through a geometric center of gravity of the ejection port 76a. The hand-held power tool 118a comprises an actuating element 88a, which is in particular different from the operating element 117a, for controlling the grinding device 12a (cf. FIG. 2), for example, for adapting a rotational velocity of the grinding pad 132a. For example, the operating element 117a is designed as a control dial. The operating element 117a and the material collection container 112a are arranged on different sides of the mounting plane 50a spanned by the rotation axis 24a and the longitudinal axis 92a. The drive housing 16a has a distance from the material collection container 112a of between 10 mm and 40 mm, preferably between 15 mm and 35 mm, particularly preferably between 20 mm and 30 mm. Preferably, the operating element 117a is arranged in the tapering region 108a. The operating element 117a and the actuating element 88a are preferably arranged on different sides of a transverse plane 98a that is perpendicular to the rotation axis 24a and in which the front portion 94a has the largest gripping-surface transverse extension 106a.

FIG. 4 shows a longitudinal section of the hand-held power tool 118a in the mounting plane 50a, and FIG. 5 shows a cross section of the hand-held power tool 118a. The grinding device 12a preferably comprises an eccentric driven by a drive shaft 26a. Preferably, the grinding device 12a comprises an eccentric bearing 158a, which is in particular designed as a ball bearing. Optionally, the eccentric bearing 158a comprises a plurality of ball bearings stacked on one another, in particular along the rotation axis 24a, or a multi-row, in particular a double-row, ball bearing. The eccentric bearing 158a is in particular arranged on the eccentric and preferably encompasses the eccentric in a plane perpendicular to the rotation axis 24a. The eccentric bearing 158a is in particular clamped to a shoulder of the eccentric by means of a mounting plate and a screw. In particular, a geometric center of the eccentric bearing 158a is arranged spaced apart from the rotation axis 24a. The grinding device 12a in particular comprises an annular grinding pad holder 156a. The grinding pad holder 156a is arranged on the eccentric bearing 158a and preferably encompasses it in a plane perpendicular to the rotation axis 24a. Preferably, the grinding pad holder 156a has a groove in which the eccentric bearing 158a is arranged. Particularly preferably, the eccentric bearing is over-molded with the grinding pad holder 156a. In particular, the grinding pad holder 156a can be rotated relative to the eccentric. The grinding pad 132a is preferably fastened to the grinding pad holder 156a, in particular screwed thereto in a direction parallel to the rotation axis 24a. In particular, the grinding device 12a optionally comprises a fan 66a. The fan 66a is in particular driven by the drive shaft 26a. Preferably, blades of the fan 66a surround the grinding pad holder 156a in a plane perpendicular to the rotation axis 24a, wherein the grinding pad holder 156a projects beyond the fan 66a in a direction of the rotation axis 24a. Preferably, the grinding device 12a comprises a slip ring 154a made of an elastic material, which is fastened to the connection housing unit 20a in a groove in a rotationally fixed manner with the connection housing unit 20a and in particular rests on the grinding pad 132a, in particular in order to stabilize a rotational movement of the grinding pad 132a.

Preferably, the drive device 14a comprises an electric motor 134a. The electric motor 134a in particular has a rated voltage of 12 volts. The drive device 14a comprises the drive shaft 26a, which is in particular driven by the electric motor 134a about rotation axis 24a. The drive device 14a in particular comprises an electrical supply interface 136a, in particular for connecting the battery pack 138a. Preferably, drive device 14a comprises at least one control electronics 140a, in particular for controlling the electric motor 134a. Preferably, the electric motor 134a, the control electronics 140a, and the electrical supply interface 136a are arranged along the longitudinal axis 92a, in particular in this order. In particular, the electric motor 134a is arranged in the front portion 94a. In particular, the control electronics 140a is arranged in the tapering region 108a. In particular, the electrical supply interface 136a is arranged in the longitudinal axis portion 90a. The drive shaft 26a preferably projects starting from the front portion 94a into the interface device 18a.

The actuating element 88a is arranged, in particular embedded, in a partial surface of the gripping surface 96a arranged obliquely to the longitudinal axis 92a and the rotation axis 24a. The partial surface receiving the actuating element 88a preferably has an angle of between 40° and 50° to the longitudinal axis 92a. A projection of the actuating element 88a along the rotation axis 24a in particular has no overlap with the electric motor 134a. The actuating element 88a and the grinding device 12a are arranged on different sides of the transverse plane 98a that is at least substantially perpendicular to the rotation axis 24a and in which the front portion 94a has the largest gripping-surface transverse extension 106a. More than half, preferably more than 66%, particularly more than 75% of a volume of the electric motor 134a is in particular arranged on the side of the transverse plane 98a opposite to the actuating element 88a. Between 40% and 60% of a volume of a receiving region of the electrical supply interface 136a for receiving the battery pack 138a is preferably arranged on the side of the transverse plane 98a opposite the actuating element 88a. In particular, the partial surface of the gripping surface 96a surrounding the actuating element 88a is flattened in the mounting plane 50a, in particular planar in sections. Preferably, the front portion 94a has a continuously curved profile in the transverse plane 98a. Partial surfaces of the gripping surface 96a, one of which surrounds the actuating element 88a and which terminate the front portion 94a along the longitudinal axis 92a, are arranged at a front angle 142a between 95° and 110° to one another. The front angle 142a is in particular in the mounting plane 50a. In particular, the partial surfaces terminating the front portion 94a are arranged on different sides of the transverse plane 98a having the largest gripping-surface transverse extension 106a and extending perpendicularly to the rotation axis 24a.

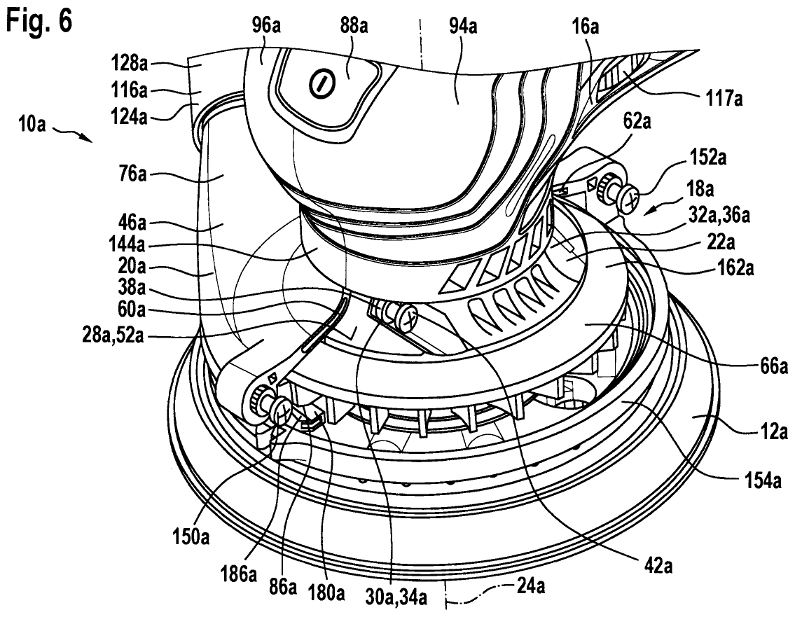

A ratio of a maximum gripping-surface height 100a, parallel to the rotation axis 24a, of the gripping surface 96a to the parallel total height 54a of the drive housing 16a is between 0.65 and 0.8, preferably between 0.7 and 0.75. In particular, the gripping surface 96a extends in a direction of the rotation axis 24a to an end of the electric motor 134a facing the grinding device 12a. Preferably, the drive device 14a comprises a drive fan 64, in particular a motor fan, in particular for cooling the electric motor 134a. The drive fan 64a is arranged at the rotation axis 24a between the electric motor 134a and the interface device 18a. Preferably, the gripping surface 96a extends in a direction of the rotation axis 24a to a fan portion 144a of the drive housing 16a, in which ventilation openings are arranged for taking in and/or blowing out air through the drive fans 64a. Preferably, the gripping-surface height 100a decreases, in particular continuously, in a direction of the longitudinal axis 92a (cf. also FIG. 6). Preferably, the drive fan 64a and longitudinal axis portion 90a are arranged, in particular completely, on different sides of a plane perpendicular to the rotation axis 24a. Preferably, the front portion 94a tapers in a direction of the rotation axis 24a toward the fan portion 144a. In particular, the actuating element 88a at least partially projects beyond the fan portion 144a along the longitudinal axis 92a. Preferably, a unit of drive housing 16a and connection housing unit 20a on the fan portion 144a has a cross section, perpendicular to the rotation axis 24a, between the actuating element 88a and the grinding device 12a with the smallest surface area. In particular, the fan portion 144a has a maximum transverse extension perpendicular to the rotation axis 24a of less than 65 mm, preferably less than 60 mm, particularly preferably less than 55 mm.

The interface device 18a comprises a docking interface 22a arranged on the drive housing 16a. The connection housing unit 20a encompasses the docking interface 22a in a fixing plane 27a perpendicular to the rotation axis 24a of the drive shaft 26a of the drive device 14a. In the fixing plane 27a, the docking interface 22a has at least one axial form-fit element 28a, 29a, 30a, 32a for forming a form fit parallel to the rotation axis 24a with the connection housing unit 20a. A projection of the axial form-fit element 28a, 29a, 30a, 32a along the rotation axis 24a is at least substantially completely in the interior of the drive housing 16a. In particular, the docking interface 22a comprises a plurality of axial form-fit elements 28a, 29a, 30a, 32a, the projections of which along the rotation axis 24a are at least substantially completely in the interior of the drive housing 16a. In particular, a projection of the entire docking interface 22a is at least substantially completely in the interior of the drive housing 16a. The docking interface 22a is preferably arranged along the rotation axis 24a at the front portion 94a. In particular, the fan portion 144a is arranged between the front portion 94a and the docking interface 22a. Preferably, the docking interface 22a is formed in a material fit with the drive housing 16a. In particular, the total height 54a of the drive housing 16a refers to an extension that is parallel to the rotation axis 24a and includes the docking interface 22a.

The docking interface 22a comprises a fixing recess 34a, 36a as axial form-fit element 30a, 32a. The fixing recess 34a, 36a preferably extends at least substantially in parallel to the fixing plane 27a. The fixing recess 34a, 36a is in particular provided to receive a fixing element 38a, 40a of the connection housing unit 20a and a separately formed fixing element 42a, 44a. The fixing element 38a, 40a of the connection housing unit 20a is designed as a sleeve, particularly preferably a screw boss. The sleeve is designed to receive the separately formed fixing element 42a, 44a. The separately formed fixing element 42a, 44a is preferably designed as a screw. A total receiving length of the sleeve in particular corresponds substantially, but in particular not completely, to a length of the separately formed fixing element 42a, 44a. In particular, the sleeve comprises two sleeve portions, one of which is arranged on each of the two main shells 46a, 48a so that an air gap exists between the two sleeve portions. In particular, the main shells 46a, 48a are fastened under tension to the docking interface 22a by tightening the separately formed fixing element 42a, 44a in the sleeve. In particular, the separately formed fixing element 42a, 44a engages in, in particular through, the docking interface 22a. Preferably, the docking interface 22a in the fixing plane 27a comprises at least two, in particular precisely two, specimens of the fixing element 38a, 40a per main shell 46a, 48a and in particular at least two, in particular precisely two, specimens of the separately formed fixing element 42a, 44a, which are arranged in particular on different sides of a plane perpendicular to the longitudinal axis 92a and comprising the rotation axis 24a. Optionally, the connection housing unit 20a comprises at least one additional fixing element 150a, 152a, which is provided to fasten the main shells 46a, 48a to one another at a position spaced apart from the fixing plane 27a. Preferably, the connection housing unit 20a comprises at least two additional fixing elements 150a, 152a, which are in particular arranged between the fixing plane 27a, in particular between an end of the docking interface 22a facing the grinding pad 132a, and the grinding pad 132a. In particular, the additional fixing elements 150a, 152a are designed as screws. Preferably, additional fixing recesses of the main shells 46a, 48a for receiving the additional fixing elements 150a, 152a are arranged in a plane that is parallel to the fixing plane 27a and has the largest transverse extension of the connection housing unit 20a in the mounting plane 50a.

The docking interface 22a comprises, as an axial form-fit element 28a, perpendicular to the rotation axis 24a, a docking cross section that tapers along the rotation axis 24a in a direction pointing away from the grinding device 12a and in particular leading toward the fan portion 144a. In particular, the fixing recess 34a, 36a is arranged between a maximum cross section of the docking interface 22a perpendicular to the rotation axis 24a and a minimum cross section of the docking interface 22a perpendicular to the rotation axis 24a. Preferably, the docking interface 22a comprises a contact surface 52a formed on a surface of the docking interface 22a forming the taper. The contact surface 52a is in particular arranged facing away from the grinding device 12a and in particular facing the drive device 14a. On one of their respective inner walls, the main shells 46a, 48a in particular comprise a mating surface complementary to the contact surface 52a. The mating surfaces of the main shells 46a, 48a are in particular arranged on the contact surface 52a and, particularly preferably, are pressed laminarly against the contact surface 52a by means of the fixing elements 42a. The docking interface 22a comprises, as an axial form-fit element 29a, a smaller cross section at a boundary surface, at least substantially perpendicular to the rotation axis 24a, to the drive housing 16a, in particular to the fan portion 144a, than the drive housing 16a. In particular, a difference in the cross sections of the docking interface 22a and of the drive housing 16a at the boundary surface corresponds to a wall thickness, in particular twice the wall thickness, of the connection housing unit 20a. A portion of the main shells 46a, 48a forming the mating surfaces preferably extends along the contact surface to the boundary surface. The connection housing unit 20a is arranged at least substantially flush with the drive housing 16a at the docking interface 22a. The docking interface 22a, in particular the contact surface 52a, comprises at least 10% to 20% of the total height 54a of the drive housing 16a, including the docking interface 22a, parallel to the rotation axis 24a. Preferably, a ratio of a docking height of the docking interface 22a parallel to the rotation axis 24a to a maximum transverse extension, in particular a maximum diameter, of the docking interface 22a perpendicular to the rotation axis is between 0.1 and 0.3, preferably between 0.15 and 0.2. Preferably, a ratio of the docking height of the docking interface 22a parallel to the rotation axis to a minimum transverse extension, in particular a minimum diameter, of the docking interface 22a perpendicular to the rotation axis 24a is between 0.15 and 0.35, preferably between 0.2 and 0.25. Preferably, a distance parallel to the rotation axis 24a between the maximum transverse extension and the minimum transverse extension of the docking interface 22a perpendicular to the rotation axis 24a corresponds to at least 60%, preferably more than 75%, of the docking height.

The contact surface 52a extends transversely to the fixing plane 27a and is curved. The mating surface has a curvature complementary to the contact surface 52a. The curvature of the contact surface 52a, and in particular of the mating surface, is preferably concave with respect to the rotation axis 24a. A radius of curvature describing the contact surface 52a, and in particular the mating surface, extends outside the docking interface 22a, and in particular through connection housing unit 20a. The radius of curvature is between 5 mm and 15 mm, preferably between 9 mm and 10 mm. Preferably, a center of curvature associated with the radius of curvature is outside the connection housing unit 20a. Optionally, the wall thickness of the connection housing unit 20a decreases along the curvature in the direction of the drive housing 16a. Alternatively, the wall thickness of the connection housing unit 20a is constant along the curvature. Preferably, the contact surface 52a comprises a planar contact portion which tangentially continues the curvature of the docking interface 22a in the direction of the grinding pad 132a. In particular, the planar contact portion of the contact surface 52a is inclined relative to the fixing plane 27a by an angle of between 10° and 20° in the direction of the grinding pad 132a. A portion of the main shells 46a, 48a forming the mating surfaces preferably extends beyond the planar contact portion, particularly at the same angle to the fixing plane 27a as the planar contact portion of the contact surface 52a. This extension of the main shells 46a, 48a in particular continues to an end of the connection housing unit 20a in this direction or to the additional fixing recesses or to the ejection port 76a. In particular, an upper side of the main shells 46a, 48a facing the drive device 14a forms a hand resting surface, in particular a hand resting surface inclined relative to the grinding pad 132a, in particular a hand resting surface decreasing outward from the rotation axis 24a, in particular for supporting a natural hand position when thumb and index finger are arranged on different sides of the rotation axis 24a. The main shells 46a, 48a are aligned with one another by means of at least one tongue-and-groove connection 60a, 62a, in particular a curved tongue-and-groove connection, preferably a tongue-and-groove connection shaped convexly with respect to the rotation axis 24a, of the connection housing unit 20a, in the fixing plane 27a.

In FIG. 6, the interface device 18a is shown without one of the main shells 48a. The docking interface 22a in particular comprises, as a base body, a rotation body with respect to the rotation axis 24a. Alternatively, the base body of the docking interface 22a is elongated parallel to the longitudinal axis 92a and in particular has, perpendicularly to the rotation axis 24a, an ellipsoidal cross section or a cross section tapered to a point. The docking interface 22a has depressions embedded in the base body, access shafts, in particular for the sleeve of the main shells 46a, 48a and for the separately formed fixing element 42a, 44a, and/or ventilation openings.

Furthermore, it can be seen in FIGS. 4 and 5 that the interface device 18a comprises a transmission element 58a. The transmission element 58a of the interface device 18a is in particular designed as an eccentric shaft. The transmission element 58a of the interface device 18a is preferably formed separately from the drive device 14a and the grinding device 12a. Preferably, the transmission element 58a of the interface device 18a is pressed onto the drive shaft 26a along the rotation axis 24a and is in particular rotationally fixedly connected to the drive shaft 26a. Preferably, the eccentric, in particular together with already mentioned the mounting plate, is screwed to the transmission element 58a of the interface device 18a and is in particular rotationally fixedly connected to the transmission element 58a of the interface device 18a. Alternatively, the transmission element 58a is formed integrally with the drive shaft 26a or with the eccentric of the grinding device 12a. The docking interface 22a encompasses a bearing element 56a of the drive device 14a in the fixing plane 27a, which bearing element is configured to rotatably mount the transmission element 58a of the interface device 18a. Preferably, the drive shaft 26a extends along the rotation axis 24a into the bearing element 56a, particularly through bearing element 56a. Preferably, the transmission element 58a surrounds the drive shaft 26a in the fixing plane 27a so that the drive shaft 26a is in particular not in direct contact with the bearing element 56a. In particular, the bearing element 56a is designed as a ball bearing. Preferably, the transmission element 58a of the interface device 18a extends along the rotation axis 24a through the bearing element 56a. In particular, the transmission element 58a of the interface device 18a comprises, for an axial form fit along the rotation axis 24a with the bearing element 56a, a greater maximum transverse extension perpendicular to the rotation axis 24a on a side of the fixing plane 27a that faces the drive device 14a than on a side of the fixing plane 27a that faces the grinding device 12a. Preferably, the fan 66a of the grinding device 12a is arranged on the transmission element 58a of the interface device 18a, in particular for centric rotation about the rotation axis 24a. The fan 66a is not shown in FIG. 5 in order to provide a view of an inner wall 70a of the main shells 46a, 48a.

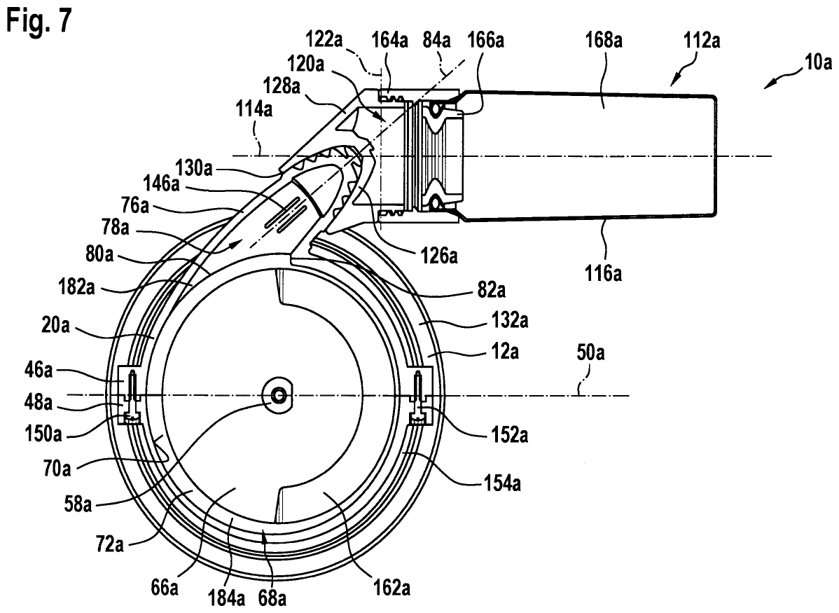

The fan 66a is designed asymmetrically to form a transmission element of the grinding device 12a. In particular, the fan 66a forms the eccentric. In particular, the fan 66a has a disk-shaped base plate, in particular a solid disk-shaped base plate, to which the blades of the fan 66a are fastened. The base plate preferably faces the docking interface 22a and is in particular arranged in the same plane perpendicular to the rotation axis 24a as the additional fixing elements 150a, 152a. The blades of the fan 66a preferably face the grinding pad 132a. In particular, the fan 66a comprises, as an eccentric, a central shaft that is surrounded by the blades in a plane perpendicular to the rotation axis 24a. In particular, the central shaft is arranged eccentrically to the base plate on the base plate. The transmission element 58a of the interface device 18a preferably engages in the central shaft of the fan 66a forming the eccentric and is in particular connected thereto in a rotationally fixed manner (cf. FIG. 7). Preferably, the fan 66a has at least one fan counterweight 148a arranged within the blades. In particular, a shape of the fan counterweight 148a is adapted to a shape of the blades. Preferably, the base plate of the fan 66 has a lowered portion 162a, which is arranged at an offset from the remaining base plate at least substantially in parallel to the rotation axis 24a. The lowered portion 162a is in particular semi-annular. The lowered portion 162a and the fan counterweight 148a, in particular together with a part of the blades, is preferably arranged at the lowered portion 162a. In a section of the fan 66a along a plane comprising the rotation axis 24a, the lowered portion 162a and the fan counterweight 148a are arranged in particular in a half of the fan 66a, that comprises a smaller volume fraction of the central shaft designed as an eccentric. A height of the blades at the lowered portion 162a and parallel to the rotation axis 24a is preferably smaller than a height of the remaining part of the blades, in particular such that all blades of the fan 66a have a common terminating plane perpendicular to the rotation axis 24a. The drive fan 64a of the drive device 14a and the fan 66a of the grinding device 12a are arranged in a direction of the rotation axis 24a on different sides of the axial form-fit element 28a, 29a, 30a, 32a. In particular, the docking interface 22a terminates a receiving space of the drive housing 16a in which the drive fan 64a is arranged, at the boundary surface. In particular, one end of the docking interface 22a along the rotation axis 24a delimits a fan receiving region 68a in which the fan 66a is arranged.

The grinding device 12a comprises the fan 66a for transporting away material removed during a grinding operation. The inner wall 70a of the connection housing unit 20a that delimits the fan receiving region 68a, for guiding an air flow generated by the fan 66a is funnel-shaped about the rotation axis 24a of the drive shaft 26a of the drive device 14a. In particular, the fan receiving region 68a narrows along the rotation axis 24a starting from the plane, perpendicular to the rotation axis 24a, in which the additional fixing elements 150a, 152a are arranged, in the direction of the grinding pad 132a. The main shells 46a, 48a of the connection housing unit 20a at least partially surround the fan 66a in the mounting plane 50a parallel to the rotation axis 24a. In particular, the main shells 46a, 48a surround the fan 66a, in particular the blades thereof, in a direction parallel to the rotation axis 24a. In particular, the main shells 46a, 48a comprise at least one bottom portion 180a arranged between the fan 66a and the grinding pad 132a. The connection housing unit 20a in particular comprises an air inlet 74a. The air inlet 74a is preferably arranged in the bottom portion 180a of the main shells 46a, 48a. In particular, the bottom portion 180a comprises a bottom surface that faces the fan 66a and is at least substantially perpendicular to the rotation axis 24a. A maximum transverse extension of the bottom surface perpendicular to the rotation axis 24a is in particular smaller than a maximum transverse extension of the fan 66a perpendicular to the rotation axis 24a. The grinding pad holder 156a in particular projects through the air inlet 74a, in particular without contact with the main shells 46a, 48a. Preferably, the eccentric bearing 158a, the transmission element 58a, and/or the eccentric are arranged at least substantially flush with the bottom portion 180a of the main shells 46a, 48a or are arranged at an offset relative to the bottom portion 180a in the direction of the drive device 14a.

The inner wall 70a is segmented in a direction of the rotation axis 24a. An orifice 78a of the ejection port 76a of the connection housing unit 20a and the air inlet 74a of the connection housing unit 20a are arranged in different segments of the inner wall 70a. The orifice 78a is in particular arranged in an ejection segment 182a of the connection housing unit 20a. The inner wall 70a preferably extends in the ejection segment 182a at least substantially perpendicularly to the rotation axis 24a. The ejection segment 182a is in particular arranged in the plane with the additional fixing elements 150a, 152a. Preferably, the connection housing unit 20a comprises at least one guide segment 184a arranged in a direction of the rotation axis 24a between the ejection segment 182a and the bottom portion 180a. The inner wall 70a in the guide segment 184a in particular extends at an acute angle to the rotation axis 24a. Preferably, the connection housing unit 20a comprises at least one further guide segment 186a, which is arranged between the guide segment 184a and the bottom portion 180a. In particular, the inner wall 70a in a further guide segment 186a has an angle to the rotation axis 24a that is greater than the angle of the guide segment 184a to the rotation axis 24a. In particular, the portions of the ejection segment 182a, the guide segment 184a, the further guide segment 186a, and the bottom portion 180a, and the portion, forming the mating surface, of one of the main shells 46a, 48a are integrally formed with one another.

The connection housing unit 20a comprises a conical spiral path 72a arranged on the inner wall 70a. The spiral path 72a in particular leads from the air inlet 74a of the connection housing unit 20a in a direction of the rotation axis 24a to the ejection port 76a of the connection housing unit 20a. In particular, the conical spiral path 72a is arranged in the guide segment 184a. FIG. 7 shows a cross section, perpendicular to the rotation axis 24a, through the ejection segment 182a. The fan receiving region 68a is preferably designed asymmetrically. In particular, due to the spiral path 72a, the inner wall 70a has a distance to the rotation axis 24a in a plane perpendicular to the rotation axis 24a that depends on an angular position relative to the rotation axis 24a. The orifice 78a of the ejection port 76a, together with the inner wall 70a, in particular forms a separating edge 82a that is at least substantially parallel to the rotation axis 24a. Preferably, the distance of the inner wall 70a from the rotation axis 24a is smallest at the separating edge 82a. Preferably, the distance of the inner wall 70a from the rotation axis 24a increases continuously or remains constant in sections. Particularly preferably, the distance of the inner wall 70a from the rotation axis 24a increases linearly with an angular difference from an angular position of the separating edge 82a, shown here in particular clockwise. Optionally, the spiral path 72a is formed in only one of the main shells 48a, while the distance of the guide segment 184a is kept constant in sections in the main shell 46a with the ejection port 76a. Preferably, the conical spiral path 72a has a pitch, parallel to the rotation axis 24a, at which the spiral path 72a leads from the further guide segment 186a to the orifice 78a in at most one turn, preferably half a turn. The guide segment 184a of the inner wall 70a forming the spiral path 72a has an angle of between 25 and 40°, preferably between 30° and 35°, to the rotation axis 24a in a plane comprising the rotation axis 24.

Preferably, the spiral path 72a, in particular the guide segment 184a, does not have an overlap with the fan 66a in a projection along the rotation axis 24. Preferably, in a projection along the rotation axis 24, more than 50%, in particular more than 75%, preferably more than 90%, of the further guide segment 184a is arranged in the interior of the fan 66a. The blades of the fan 66a have a chamfer 86a (see FIG. 4). The chamfer 86a is arranged transversely to the rotation axis 24a and at least substantially in parallel to the further guide segment 186a of the inner wall 70a. Preferably, the inner wall 70a in the further guide segment 186a, and in particular the chamfer 86a, has an angle to the rotation axis 24a of between 50° and 70°, in particular between 55° and 65°, in a plane comprising the rotation axis 24.

A further separating edge 80a formed by the orifice 78a of the ejection port 76a of the connection housing unit 20a extends at least substantially perpendicularly to the rotation axis 24a. In particular, the further separating edge 80a separates the ejection segment 182a from the guide segment 184a. The further separating edge 80a in particular continues the spiral path 72a in the region of the orifice 78a to the separating edge 82a at a constant distance from the rotation axis 24a. The further separating edge 80a is in particular arranged at a height along the rotation axis 24a between the base plate of the fan 66a and the terminating plane of the blades. The separating edge 82a formed by the orifice 78a of the ejection port 76a of the connection housing unit 20a and at least substantially parallel to the rotation axis 24a is designed to taper to a point and has a radius of curvature of less than 10 mm, preferably less than 3 mm, particularly preferably less than 2 mm. The radius of curvature of the separating edge 82a is in particular in a plane perpendicular to the rotation axis 24a. The radius of curvature of the separating edge 82a describes, in particular independently of an exact shaping of the separating edge 82a, a smallest imaginary circle that touches both the inner wall 70a facing the fan 66a and an inner wall of the ejection port 76a. Preferably, tangents touching the inner wall 70a and the inner wall of the ejection port 76a enclose an angle of between 45° and 65°, preferably between 55° and 60°, in a plane perpendicular to the rotation axis 24a.

The channel longitudinal axis 84a extends centrally through the ejection port 76a and in particular specifies a main flow direction of air through the ejection port 76a. A projection of the channel longitudinal axis 84a along the rotation axis 24a preferably tangentially touches an outer contour of the fan 66a. Preferably, the projection of the channel longitudinal axis 84a along the rotation axis 24a encloses an angle of between 40° and 50°, particularly preferably between 44° and 46°, to the mounting plane 50a. An inner wall of the ejection port 76a opposite the separating edge 82a preferably extends from the mounting plane 50a to an ejection opening of the ejection port 76a, wherein a distance of said inner wall from the rotation axis 24a in the mounting plane 50a is adapted to the distance of the spiral path 72a and increases continuously in the direction of the ejection opening. The channel longitudinal axis 84a of the ejection port 76a of the connection housing unit 20a encloses an acute angle, in particular between 15° and 35°, preferably between 20° and 30°, with a plane perpendicular to the rotation axis 24a. The channel longitudinal axis 84a is inclined in a direction of the rotation axis 24a, in particular starting from the orifice 78a away from the grinding device 12a. At the orifice 78a, the ejection port 76a in particular has a rectangular cross section perpendicular to the channel longitudinal axis 84a. At the ejection opening, the ejection port 76a preferably has a circular cross section perpendicular to the channel longitudinal axis 84a. A protection device 146a, in particular in the form of bars parallel to the channel longitudinal axis 84a, for avoiding a finger and/or other debris being introduced into the ejection port 76a, is preferably arranged in a portion of the ejection port 76a that has the rectangular cross section.

In particular, the material collection device 116a is arranged at the region of the ejection port 76a with the circular cross section. The material collection container 112a has at least one opening 120a for feeding the material into the material collection container 112a. The opening 120a of the material collection container 112a is arranged in an opening plane 122a. In at least one state of the material collection device 116a arranged on the ejection port 76a, the opening plane 122a can preferably be oriented at least substantially perpendicularly to the longitudinal axis 92a. Preferably, the material collection container 112a comprises exactly one opening 120a in the opening plane 122a. Alternatively, the material collection device 116a comprises, in the opening plane 122a, a structural element that divides the opening 120a into small partial openings. Preferably, the container longitudinal axis 114a of the material collection container 112a is oriented at least substantially perpendicularly to the opening plane 122a. In particular, the material collection container 112a has the largest longitudinal extension in parallel to, in particular along, the container longitudinal axis 114a. In particular, the material collection container 112a is formed rotationally symmetrically about the container longitudinal axis 114a.

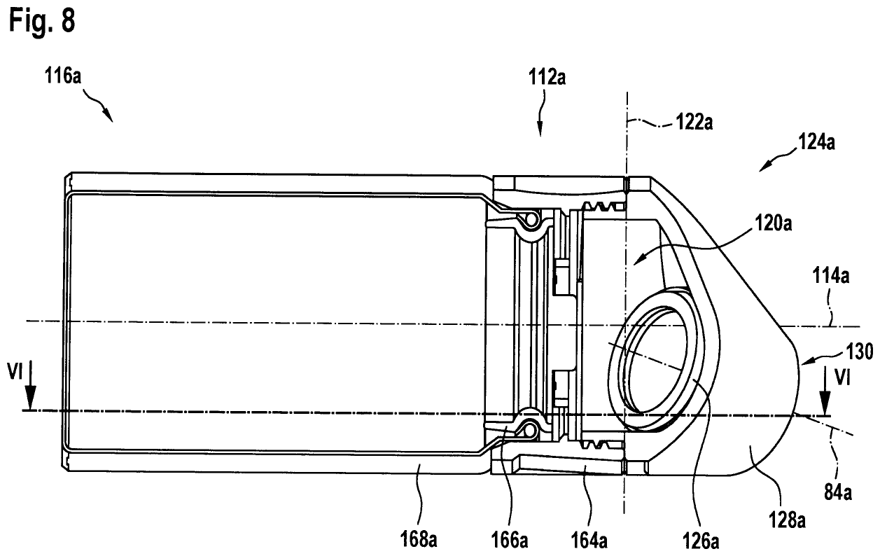

The material collection device 116a comprises at least one mounting unit 124a for mounting the material collection container 112a to the hand-held power tool 118a. The mounting unit 124a comprises the channel element 126a for connecting to the ejection port 76a of the hand-held power tool 118a. The channel element 126a is in particular provided to be concentrically arranged on the ejection port 76a and has, in a state arranged on the ejection port 76a, the same channel longitudinal axis 84a as the ejection port 76a. In at least one section plane perpendicular to the opening plane 122a, the channel longitudinal axis 84a of the channel element 126a is arranged transversely to the opening plane 122a of the material collection container 112a. In a further section plane perpendicular to the section plane and the opening plane 122a, the channel longitudinal axis 84a is arranged transversely to the opening plane 122a. In particular, the channel longitudinal axis 84a and the container longitudinal axis 114a are arranged skew to one another. FIG. 7 shows a longitudinal section, parallel to the section plane, of the hand-held power tool 118a in a configuration shown perpendicularly to the rotation axis 24a. In FIG. 8, a longitudinal section, parallel to the further section plane, of the material collection device 116a is shown. In the state of the material collection device mounted on the hand-held power tool, the container longitudinal axis 114a can be arranged at least substantially in parallel to the mounting plane 50a, in particular wherein the container longitudinal axis 114a is oriented in parallel to the longitudinal axis 92a. In an orientation of the container longitudinal axis 114a parallel to the longitudinal axis 92a, the further section plane is arranged in particular in parallel to the mounting plane 50a. The container longitudinal axis 114a of the material collection container 112a encloses an angle to the mounting plane 50a, which angle added to an angle between the channel longitudinal axis 84a and the container longitudinal axis 114a forms a sum angle of between 80° and 100°, particularly preferably of 90°. In particular, the channel longitudinal axis 84a intersects the opening plane 122a in the section plane at an angle of between 40° and 50°, preferably between 44° and 46°. In particular, the channel longitudinal axis 84a intersects the opening plane 122a in the further section plane at an angle of between 15° and 30°.

The channel element 126a is preferably attached to the ejection port 76a along the channel longitudinal axis 84a. Preferably, an inner wall of the channel element 126a and/or an outer wall of the ejection port 76a comprises structural elements for a force fit, in particular a force fit that can be released and established by hand, of the channel element 126a with the ejection port 76a, for example bars or nubs with a press fit and/or sheathing with an elastic material, or the like. Preferably, the material collection device 116a is arranged rotatably, in particular at least under a moderate amount of force, on the ejection port 76a. In particular, the moderate amount of force required to rotate the material collection device 116a on the ejection port 76a exceeds a weight force of the material collection device 116a, in particular in a state of the material collection container 112a filled with material removed by the grinding device 12a. Preferably, the moderate amount of force can be exerted by a hand without a tool and is in particular less than 200 N, preferably less than 125 N, particularly preferably less than 75 N. In particular, the material collection device 116a remains in a current rotational position with respect to the ejection port 76a without manual actuation. Rotation of the material collection device 116a about the channel longitudinal axis 84a changes a relative position of the container longitudinal axis 114a to the rotation axis 24a and/or to the longitudinal axis 92a. In particular, the material collection device 116a is arranged pivotally relative to the drive housing 16a, on the ejection port 76a. As a result, the material collection device 116a can advantageously be flexibly oriented during a grinding operation, so that even difficult-to-access surfaces can be machined.

The mounting unit 124a comprises an adapter housing 128a. The adapter housing 128a is designed to asymmetrically taper from the opening plane 122a in the direction of the channel longitudinal axis 84a. The channel element 126a at least partially projects into the adapter housing 128a. The channel element 126a is in particular rotationally symmetrical to the longitudinal axis 92a. Preferably, the channel element 126a is completely embedded in the adapter housing 128a. Particularly preferably, the channel element 126a and the adapter housing 128a are formed in one piece. The adapter housing 128a preferably comprises a mounting element for fixing the material collection container 112a to the adapter housing 128a. For example, the mounting element is designed as a thread, preferably as an external thread. In particular, the material collection container 112a comprises an air-permeable container region 168a for collecting the removed material and a fastening ring 164a for fastening the container region 168a to the mounting unit 124a. Preferably, the fastening ring 164a comprises a mounting element, for example a thread, in particular an internal thread, for connecting to the adapter housing 128a. Preferably, the container region 168a is fixed to the fastening ring 164a by means of a catch and/or screw connection 166a. In particular, the fastening ring 164a delimits the opening 120a. The fastening ring 164a and the adapter housing 128a are preferably arranged at least substantially flush with one another. The adapter housing 128a is in particular designed in the form of a truncated cone which sits askew on the fastening ring 164a and the cone axis of which is aligned coaxially with the channel longitudinal axis 84a. Preferably, a radius of a cover surface of the frusto-conical adapter housing 128a is equal to an outer radius of the channel element 126a.

A maximum adapter longitudinal extension of a portion of the mounting unit 124a protruding in a direction of the container longitudinal axis 114a beyond the material collection container 112a is less than or equal to a maximum adapter transverse extension of the mounting unit 124a in the opening plane 122a. In particular, a ratio of the adapter longitudinal extension to the adapter transverse extension is between 50% and 80%, preferably between 60% and 70%. In particular, the adapter housing 128a, in particular an inlet opening 130a of the channel element 126a, projects at most slightly beyond the material collection container 112a in a projection along the container longitudinal axis 114a. In particular, a projection of the adapter housing 128a along the container longitudinal axis 114a is completely in the interior of a smallest imaginary square that just completely includes a projection of the material collection container 112a. In particular, a maximum distance of the inlet opening 130a from the container longitudinal axis 114a is less than √2 times an outer radius of the material collection container 112a in the opening plane 122a. In FIG. 7, the material collection container 112a is divided by the section plane in a ratio of more than 1:4 so that the diameter of the material collection container 112a is not shown here, and the adapter housing 128a only appears to project significantly beyond the material collection container 112a in the direction of the grinding device 12a.

The outlet opening of the channel element 126a occupies a maximum outlet opening width of between 35% and 55%, particularly between 44% and 47%, a maximum opening width of the opening 120a in the opening plane 122a. Preferably, a ratio of an inner diameter of the channel element 126a to the opening width of the opening 120a is between 35% and 60%, preferably between 45% and 55%. Preferably, the container longitudinal axis 114a extends through an outlet opening of the channel element 126a facing the material collection container 112a. Preferably, the outlet opening of the channel element 126a is arranged in a plane that is at least substantially perpendicular to the channel longitudinal axis 84a and transverse to the opening plane 122a. A geometric center of the outlet opening of the channel element 126a is arranged at least in the further section plane, in particular at an offset from the container longitudinal axis 114a, in particular by an amount of 10% to 30% of the maximum opening width.

The inlet opening 130a of the channel element 126a extends in a plane that is at least substantially perpendicular to the channel longitudinal axis 84a, and in particular transverse to the opening plane 122a. The inlet opening 130a in particular encompasses the region of the ejection port 76a with the circular cross section. Preferably, the ejection port 76a projects into the channel element 126a to at least the container longitudinal axis 114a. The inlet opening 130a of the channel element 126a is arranged in the section plane and/or the further section plane spaced apart from the container longitudinal axis 114a of the material collection container 112a perpendicular to the opening plane 122a.

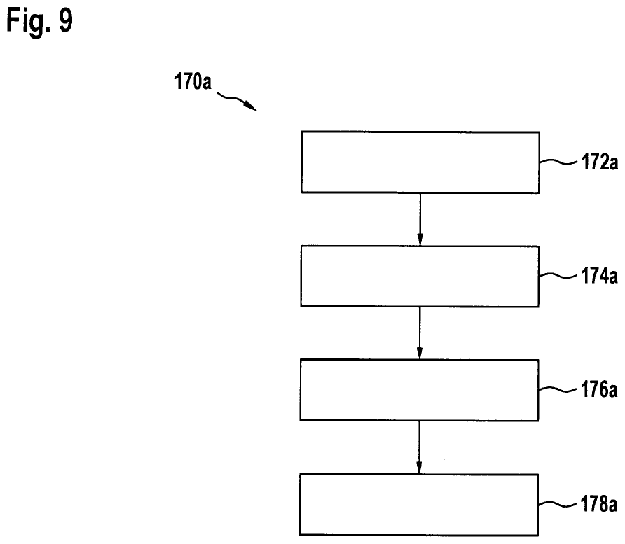

FIG. 9 shows a flow diagram of a method 170a for assembling the hand-held power tool 118a. The method 170a in particular comprises a pre-assembly step 172a. Preferably, the method 170a comprises a connection step 174a. Preferably, the method 170a comprises a half shell arrangement step 176a. In particular, the method 170a comprises a fixing step 178a. In the pre-assembly step 172a, the drive device 14a and/or the grinding device 12a are in particular pre-assembled, in particular independently of one another. In the pre-assembly step 172a, the drive device 14a is arranged in the drive housing 16a, in particular in a mounting half shell of the drive housing 16a, of the hand-held power tool 118a. In the connection step 174a, the transmission element 58a is preferably pressed onto the drive shaft 26a. In the connection step 174a, the grinding device 12a is preferably screwed to the transmission element 58a. In the main shell arrangement step 176a, a form fit, parallel to the rotation axis 24a, of the connection housing unit 20a with the docking interface 22a is formed by means of the axial form-fit element 28a, 29a, 30a, 32a of the docking interface 22a arranged in the fixing plane 27a. In the main shell arrangement step 176a, the connection housing unit 20a is arranged on the docking interface 22a in a manner that encompasses the docking interface 22a in the fixing plane 27a perpendicular to the rotation axis 24a. In particular, in the main shell arrangement step 176a, the main shells 46a, 48a are placed on the docking interface 22a. In particular, the mating surfaces of the main shells 46a, 48a are placed on the contact surface 52a, wherein the grinding device 12a is at least partially arranged in the connection housing unit 20a. Preferably, in the main shell arrangement step 176a, the sleeve of the main shells 46a, 48a is inserted into the fixing recesses 34a, 36a of the docking interface 22a. The main shells 46a, 48a are placed on one another in particular in the mounting plane 50a. In the fixing step 178a, the separately formed fixing element 42a, 44a is arranged in the sleeve arranged in the fixing recess 34a, 36a and thereby presses the main shells 46a, 48a together and against the docking interface 22a, in particular the contact surface 52a. Preferably, the fixing elements 42a, 44a, the additional fixing elements 150a, 152 and optionally drive housing fixing elements for connecting the mounting half shells of the drive housing 16a are all mounted on the main shells 46a, 48a, the docking interface 22a and/or the drive housing 16a, from the same direction at least substantially perpendicular to the mounting plane 50a.

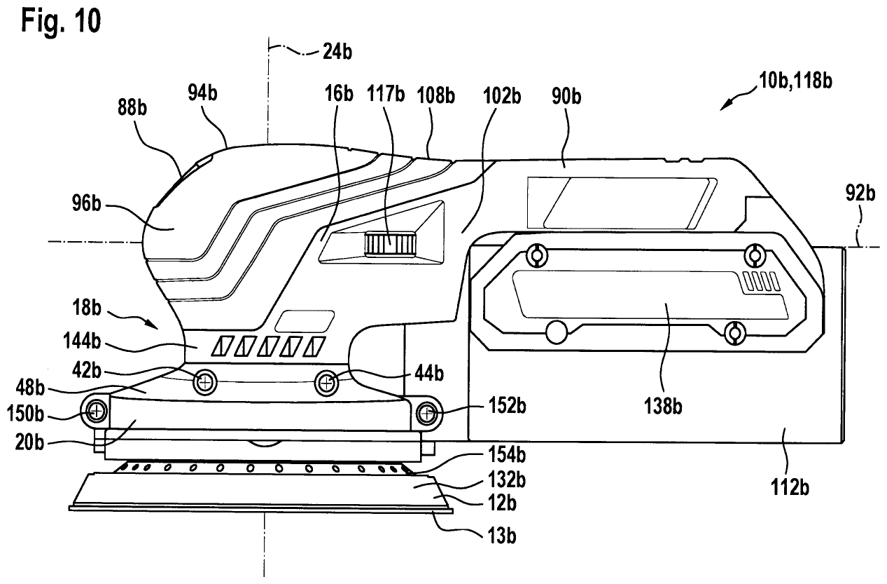

FIGS. 10 to 15 show further exemplary embodiments of the disclosure. The following descriptions and the drawings are substantially limited to the differences between the exemplary embodiments, wherein reference can basically also be made to the drawings and/or the description of the other exemplary embodiments, in particular of FIGS. 1 to 9, with respect to identically designated components, in particular with respect to components having the same reference signs. In order to distinguish the exemplary embodiments, the letter a is added to the reference signs of the exemplary embodiment in FIGS. 1 to 9. In the exemplary embodiments of FIGS. 10 to 15, the letter a is replaced by letters b to d.

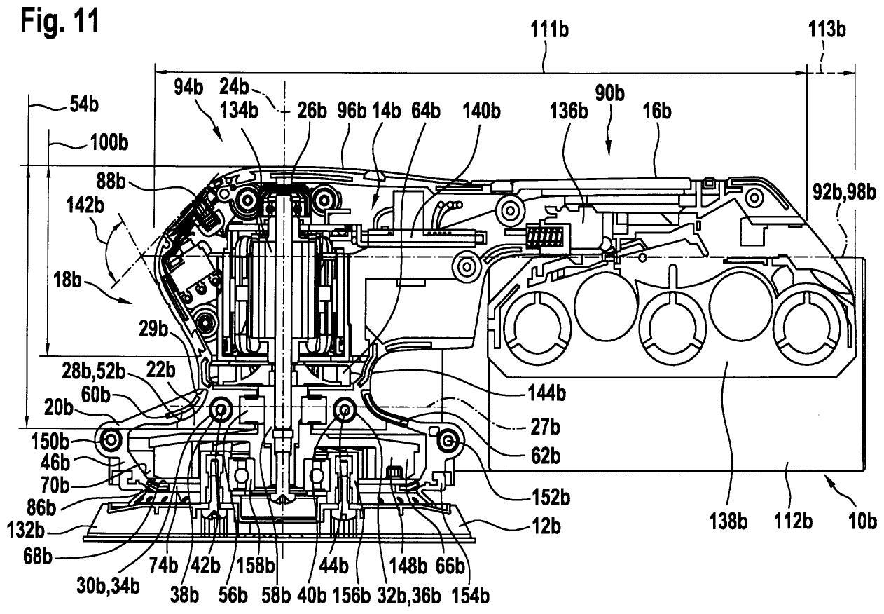

FIG. 10 shows an external view and FIG. 11 shows a longitudinal section of a hand-held power tool 118b designed as a random orbit sander. The hand-held power tool 118b comprises a grinding device 12b, which is in particular identical to the grinding device 12a of the previous exemplary embodiment. The hand-held power tool 118b comprises a drive device 14b, in particular with an electric motor 134b. The electric motor 134b in particular has a rated voltage of 18 volts. Preferably, an electrical supply interface 136b of the drive device 14b and a longitudinal axis portion 90b of a drive housing 16b of the hand-held power tool 118b is designed to receive an 18-volt battery pack 138b. The hand-held power tool 118b comprises an interface device 18b with a docking interface 22b and a connection housing unit 20b. The connection housing unit 20b preferably has a counterweight which compensates for a torque caused by a weight of the battery pack 138b, in particular in order to avoid tilting of a rotation axis 24b of the drive device 14b. Preferably, the counterweight is arranged on, in particular integrated in, main shells 46b, 48b of the connection housing unit 20b. Optionally, the main shells 46b, 48b are made of metal, in particular by means of an aluminum-zinc die-casting process, to form the counterweight. Alternatively, the main shells 46b, 48b comprise, as a counterweight, metal inclusions in a plastic body. The counterweight and the electrical supply interface 136b are in particular arranged on different sides of a plane that is perpendicular to a longitudinal axis 92b of the hand-held power tool 118b and comprises the rotation axis 24b. Preferably, a portion of the connection housing unit 20b with the counterweight rests on a docking interface 22b of the interface device 18b. In particular, the portion of the connection housing unit 20b with the counterweight has a greater wall thickness than a portion of the connection housing unit 20b that is arranged on the side opposite to the plane that is perpendicular to the longitudinal axis 92b and comprises the rotation axis 24b. Preferably, the portion of the connection housing unit 20b with the counterweight has an outer surface that faces the drive housing 16b and is inclined in the direction of the grinding device 12b by 15° to 30° relative to a plane perpendicular to the rotation axis 24b. With respect to further features of the hand-held power tool 118b, reference is made to FIGS. 1 to 9 and their description.

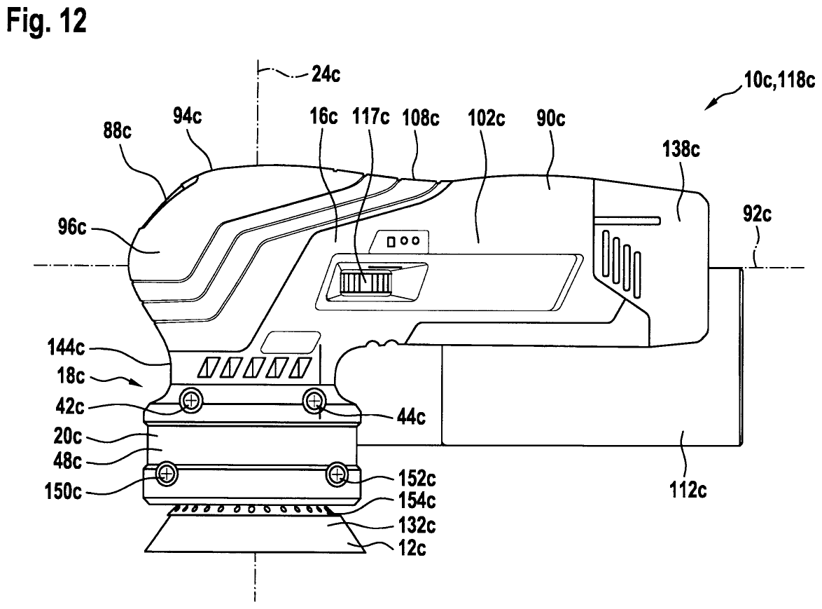

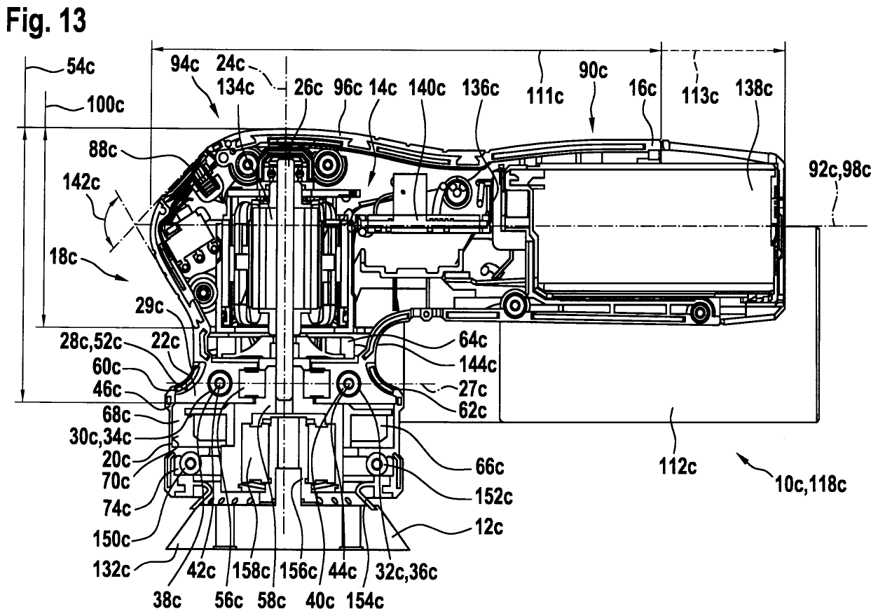

FIG. 12 shows an external view and FIG. 13 shows a longitudinal section of a hand-held power tool 118c. The hand-held power tool 118c comprises a drive device 14c and a drive housing 16c, which are in particular identical to the drive device 14a and the drive housing 16a of the first exemplary embodiment, respectively. Alternatively, a grinding device 12c of the hand-held power tool 118c, in particular without further adaptation, may also be combined with a drive device and a drive housing 16c, as shown in the second exemplary embodiment. A grinding pad 132c of the grinding device 12c has, for example, a diameter of between 70 mm and 80 mm, preferably between 77 and 78 mm. In particular, the entire grinding device 12c and an interface device 18c of the hand-held power tool 118c are in the interior of the drive housing 16c in a projection along a rotation axis 24c of the drive device 14c. A docking interface 22c of the interface device 18c is in particular identical to the docking interfaces 22a, 22b of the previous exemplary embodiments. A connection housing unit 20c of the interface device 18c is in particular adapted to a height of the grinding device 12c parallel to the rotation axis 24c. Preferably, a maximum transverse extension of the connection housing unit 20c perpendicular to the rotation axis 24c is insignificantly, in particular only by a wall thickness, in particular twice the wall thickness, of the connection housing unit 20c, greater than a maximum transverse extension of the docking interface 22c. In particular, a portion of the connection housing unit 20c at least substantially parallel to the rotation axis 24c is arranged directly on the docking interface. In particular, additional fixing elements 150c, 152c are arranged with a contact surface 52c of the docking interface 22c in a plane parallel to the rotation axis 24c. A transmission element 58c of the interface device 18c engages through an optional fan 66c along the rotation axis. In particular, the transmission element 58c is formed integrally with an eccentric of the grinding device 12c for driving the grinding pad 132c. The transmission element 58c encompasses an eccentric bearing 158c of the grinding device 12c, in particular in a plane perpendicular to the rotation axis 24c. The eccentric bearing 158c preferably encompasses a grinding pad holder 156c of the grinding device 12c in a plane perpendicular to the rotation axis 24c. The grinding pad holder 156c in particular receives a continuation of the grinding pad 132c in a direction parallel to the rotation axis 24c. With respect to further features of the hand-held power tool 118c, reference is made to FIGS. 1 to 11 and their description.

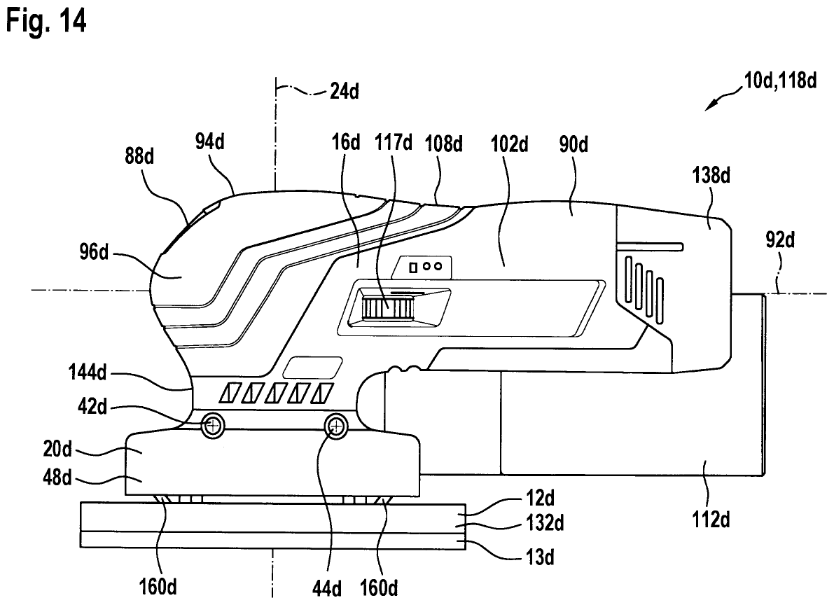

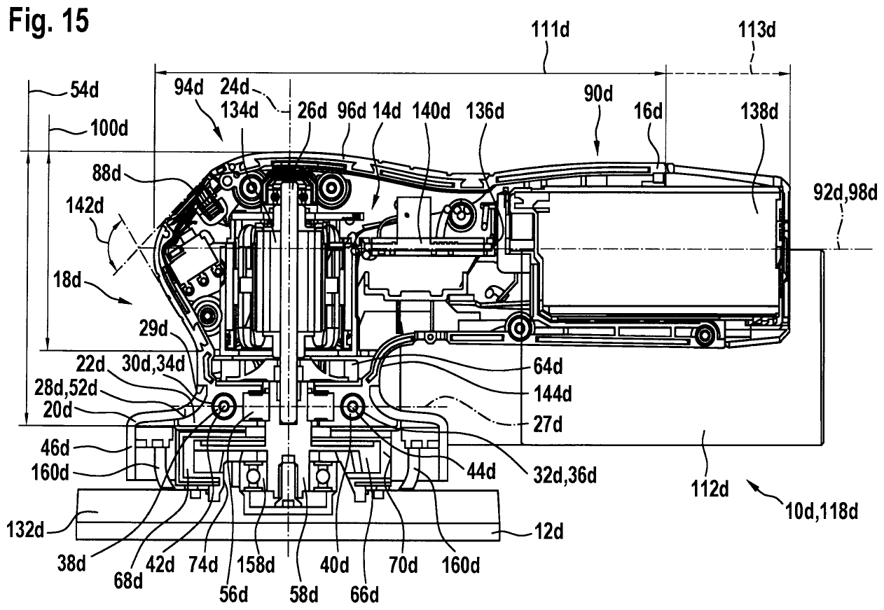

FIG. 14 shows an external view and FIG. 15 shows a longitudinal section of a hand-held power tool 118d. The hand-held power tool 118d is in particular designed as an oscillating sander. The hand-held power tool 118d comprises a drive device 14d and a drive housing 16d, which are in particular identical to the drive device 14a and the drive housing 16a of the first exemplary embodiment, respectively. Alternatively, a grinding device 12d of the hand-held power tool 118d, in particular without further adaptation, may also be combined with a drive device and a drive housing, as shown in the second exemplary embodiment. A grinding pad 132d of the grinding device 12d is in particular fastened to a connection housing unit 20d of an interface device 18d of the hand-held power tool 118d by means of an elastic bracket 160d. A fan 66d of the grinding device 12d is arranged in a fan housing of the grinding device 12d, which fan housing is in particular arranged within the connection housing unit 20d. The elastic bracket 160d is in particular arranged between the fan housing and the connection housing unit 20d. A transmission element 58d of the interface device 18d is preferably formed integrally with an eccentric of grinding device 12d. An eccentric bearing 158d of the grinding device 12d in particular encompasses the transmission element 58d in a plane perpendicular to a rotation axis 24d of the drive device 14d. The eccentric bearing 158d is in particular arranged in a guide ring of the grinding pad 132d that can be deflected by the eccentric bearing 158d, and is preferably connected to the guide ring in a force fit. With respect to further features of the hand-held power tool 118d, reference is made to FIGS. 1 to 13 and their description.

1. A material collection device for a hand-held power tool, comprising:
a material collection container configured to collect material removed during operation of the hand-held power tool, wherein at least one opening of the material collection container is configured to feed the material into the material collection container, and wherein the at least one opening is arranged in an opening plane; and
at least one mounting unit configured to mount the material collection container on the hand-held power tool, the at least one mounting unit comprising a channel element configured to connect to an ejection port of the hand-held power tool,
wherein a channel longitudinal axis of the channel element is arranged transversely to the opening plane of the material collection container in at least one section plane perpendicular to the opening plane.

2. The material collection device according to claim 1, wherein the channel longitudinal axis is arranged transversely to the opening plane in a further section plane perpendicular to the section plane and the opening plane.

3. The material collection device according to claim 1, wherein the at least one mounting unit comprises an adapter housing which is asymmetrically tapered from the opening plane in a direction of the channel longitudinal axis and into which the channel element at least partially projects.

4. The material collection device according to claim 1, wherein an inlet opening of the channel element extends in a plane that is at least substantially perpendicular to the channel longitudinal axis and is transverse to the opening plane.

5. The material collection device according to claim 1, wherein an inlet opening of the channel element is arranged spaced apart from a container longitudinal axis of the material collection container that is perpendicular to the opening plane.

6. The material collection device according to claim 1, wherein a maximum adapter longitudinal extension of a portion of the at least one mounting unit protruding beyond the material collection container is less than or equal to a maximum adapter transverse extension of the at least one mounting unit in the opening plane.

7. The material collection device according to claim 1, wherein an outlet opening of the channel element occupies a maximum outlet opening width of between 35% and 55% of a maximum opening width of the opening in the opening plane.

8. A hand-held power tool comprising:
a material collection device including (i) a material collection container configured to collect material removed during operation of the hand-held power tool, wherein at least one opening of the material collection container is configured to feed the material into the material collection container, and wherein the at least one opening is arranged in an opening plane, and (ii) at least one mounting unit configured to mount the material collection container on the hand-held power tool, the at least one mounting unit comprising a channel element configured to connect to an ejection port of the hand-held power tool,
wherein a channel longitudinal axis of the channel element is arranged transversely to the opening plane of the material collection container in at least one section plane perpendicular to the opening plane.

9. The hand-held power tool according to claim 8, wherein a container longitudinal axis of the material collection container perpendicular to the opening plane encloses an angle to a mounting plane spanned by a longitudinal axis extending perpendicularly to a rotation axis of a drive shaft and the rotation axis, which angle added to an angle between the channel longitudinal axis and the container longitudinal axis forms a sum angle of between 80° and 100°.

10. The hand-held power tool according to claim 8, wherein:
in a state of the material collection device mounted on the hand-held power tool, a container longitudinal axis perpendicular to the opening plane is arranged at least substantially in parallel to a mounting plane spanned by a longitudinal axis of a drive housing of the hand-held power tool extending perpendicularly to a rotation axis of a drive shaft and the rotation axis, and
the container longitudinal axis is oriented in parallel to the longitudinal axis.

11. The hand-held power tool according to claim 8, further comprising:
a drive housing located a distance from the material collection container that is between 10 mm and 40 mm.
